(19) United States
(12) Patent Application Publication
(10) Pub. No.: US 2026/0021445 A1
(43) Pub. Date: Jan. 22, 2026

(54) HANSON WATER PRODUCTION SYSTEM IMPROVEMENTS AND CONDENSATION FARMS ARRANGEMENTS

(71) Applicant: Matthew Vernon Hanson, Sun Prairie, WI (US)

(72) Inventor: Matthew Vernon Hanson, Sun Prairie, WI (US)

(21) Appl. No.: 19/283,598

(22) Filed: Jul. 29, 2025

Related U.S. Application Data
(63) Continuation-in-part of application No. 18/232,667, filed on Aug. 10, 2023.
(63) Continuation-in-part of application No. 19/255,877, filed on Jun. 30, 2025.

(51) Int. Cl. B01D 53/26; B01D 53/30; B64G 1/40; C02F 1/00; C02F 1/32; C02F 1/44; C02F 1/68; C02F 9/00; C10L 3/10; E03B 3/28

(52) U.S. Cl. CPC B01D 53/265; B01D 53/30; B64G 1/4024; C02F 1/008; C02F 9/00; C10L 3/10; E03B 3/28; C02F 1/001; C02F 1/32; C02F 1/441; C02F 1/68; C02F 2201/005; C02F 2201/009; C02F 2209/008; C02F 2209/02; C02F 2209/06; C02F 2209/10

(57) ABSTRACT

The instant application describes improvements to application Ser. Nos. 18/262,667 and 19/255,877. These improvements include advancements in internal small pipe geometry, the inclusion of hydrophilic surface coatings to all forms of the invention, and improvements in complex internal tunnel geometry. Additional iterations of the inventions include spaceship-based, dirigible-based, and elevation-based systems. Practical application models for real world deployment are also discussed as are possible installations for educational purposes.

### BACKGROUND OF THE INVENTION

The instant application is a deepening and extension of patent application Ser. No. 18/232,667 (the “667 Application”), as well as application Ser. No. 19/255,877 (the “877 Application”) including additional embodiments, configurations, and additions to the design, as well as a panoply of variations which make the invention more efficient, robust, and increase overall water production.

Both the 667 and 877 applications describe water production systems using subsurface temperatures as a free refrigerant in the process of condensing water from humid air, using both high compression and low compression configurations.

The first section below describes changes and improvements to the structure of the pipes or tunnels. Some of these geometries are drawn analogously from existing HVAC systems—except in reverse.

HVAC systems seek to dump heat to external environments through substantial flow mixing in a pressurized coil filled with refrigerant.

Here, by contrast, we are trying to create additional cooling surface area underground to increase a) the amount of surface area inside of a cooling pipe or tunnel, as well as b) to create geometries which disrupt laminar flow across a surface and thereby disrupt the boundary layer so that humid air is more constantly and consistently in contact with the cooling surfaces of the invention.

HVAC systems work “from the inside out” to dump the maximum amount of excess heat in the least amount of time possible; but in this application we are instead working towards greater water condensation inside of pipes or tunnels—so we are working “from the outside in.”

The general idea is the same as HVAC systems, but the internal geometries of a pipe or tunnel that are geared toward greater condensation are by necessity different, more complex, and geared toward achieving a different goal.

Additionally, we discuss various possible surface coatings and construction materials which can be used both to drop capital expenditure costs when building the various configurations of the invention, as well as increase overall condensation in each of the invention's formats.

The goal of this application is to provide a series of complete buildable systems which can be handed off to developers and/or contractors and modified to the requirements of the end user—whether that end user is a municipality, town, farmer, or business.

I foresee a variety of uses for the system across a wide range of environments—from deserts, to small communities, to use by oil companies, to the automotive industry, all the way up to large municipalities, and large-scale deployment in geographical regions which are consistently plagued by drought.

In short, with sufficient capital investment into the various formats of this invention, and a longer-term view, Mankind can basically eradicate all future water shortages. Forever.

### BACKGROUND OF THE INVENTION

The background of the invention and the reason the invention is important to the future of worldwide water production and water management has been addressed in both the 667 and 877 Applications—and that background does not really require any further additions or repetitions here.

However, it is interesting to note that as of this writing at least two of the 667 Application's Claims have been granted, opening the door to improvements and further embodiments of the basic design.

It is the hope of this inventor that the instant application will inspire future generations to make improvements to that design—based on experience, experimentation, advancements in materials, and with a view towards a more vibrant and peaceful future for all. The more water everyone has available, the easier it will be for us all to get along.

Many current conflicts worldwide—between nations, population centers, states, and businesses—are the result of a lack (or perceived lack) of water.

With this invention, and sufficient capital investment, not only can those conflicts, and all future conflicts over water, end; but it should, in time, be possible to completely suspend Mankind's use of aquifers.

That means groundwater can be given a chance to recover from Mankind's historically heavy use of it.

It also means that over the very long term we can do away with dams, and a variety of systems which currently draw heavily on the natural resources of our world.

There are 12,900 cubic kilometers of water trapped in the Earth's atmosphere at any given time.

Mankind uses 4,300 cubic kilometers of water per year (including agricultural use) worldwide.

That means the entirety of Mankind's water usage can eventually be extracted from the atmosphere—as opposed to drawing it up from underground.

Current methods of drawing water from aquifers, lakes, and rivers (such as the Colorado River), or using large-scale desalination are either unsustainable over the long-term or are energy intensive.

What's even more interesting to note is that the 12,900 cubic kilometers of water suspended in Earth's atmosphere at any given time-recycles every 9-10 days.

So, in a given year, the global atmospheric water system has a potential pool of 36×12,900 cubic kilometers—or 464,400 cubic kilometers of water to draw from. And that pool of water is constantly renewed year over year.

That is a factor of 108× of Mankind's current usage.

Meaning that Mankind can take all of the water it needs from the atmosphere without touching a drop of water from rivers, lakes, streams, or aquifers—108 times over. And do the same next year. And the next.

And what that means is that with this invention, we truly can create a paradise of our world. The deserts can be made to bloom. And agriculture can thrive everywhere—particularly in parts of the globe where water is currently scarce.

And all we really need to do is invest sufficient capital, build the various iterations of system when and where appropriate, and let the water flow—into communities, and farms, and into the lives of every single person on the planet.

And better yet—with a bit of solar and wind power—we can transform a significant portion of that excess water into hydrogen and oxygen via electrolysis.

Meaning that with this invention, again over the very long-term, Mankind can theoretically do away entirely with fossil fuels. Especially since the amount of water required to replace all fossil fuels each year (496 Exajoules) would require only 37.2 cubic kilometers of water converted to 4.13 billion metric tons of hydrogen.

So, the atmosphere has enough water to replace all fossil fuels 12,900/37.2 or 346.7 times over. Each year.

And if you take into account the 9-10-day window when all water in the atmosphere is recycled globally, that means in a given year, atmospheric water can replace all fossil fuels 464,400/37.2 or 12,483.8 times over.

The atmosphere—is the new oil field, ladies and gentlemen. Water is the new oil. And this invention is your oil derrick—the way to pump water from the air just like you pump oil from the ground. Though, quite ironically, in reverse. Oil is pumped from underground up—and this invention pumps the atmosphere below ground to extract water from it.

If water becomes the primary source of energy, it means that Climate Change could eventually become a thing of the past—and the Earth could return to a gentler climate, with fewer storms and hurricanes.

The result of this invention-an unending cornucopia of water—could support all of Mankind—with plenty of food, and energy for homes, industry, and transportation—worldwide. A world economy run almost entirely on water and its by-products.

Best of all—every human being on the planet can wake up every morning, turn on the tap, have a cool glass of water to drink, take a shower, flush their toilet, water their lawn, and get a cup of coffee: including someone who walks out on their porch with a cup of coffee in hand—and looks out over endless fields of crops—in what used to be the Sahara.

A pipe dream, you might say—and indeed it is. Underground pipes and tunnels using the Earth itself to condense water from the air, and as a result providing all of the water Mankind will ever need.

And for those heading to Mars in the centuries to come—the Martian atmosphere, while thin, at night in certain areas has 80%-100% humidity.¹ So . . . pump enough Martian air underground into systems like these—and not only could people living on Mars and have plenty of water—but underground farms could thrive there. Forever.

And maybe, someday, Martian farms could be built above ground as well.

### BRIEF DESCRIPTION OF THE DRAWINGS

FIG. 1 is an example of a pipe with helical micro fins and vortex-inducing ridge patterns; and includes a cross section indicating the depths of the ridges.

FIG. 2 is an example of a pipe with helical micro fins which increase both surface area, and spin the humid air mass moving down the tunnel like a bullet in a rifled barrel.

FIG. 3 is a pipe with a mix of helical micro fins, dimples, and riblets which disrupt laminar airflow.

FIG. 4 is those same dimples and riblets in a chevron pattern.

FIG. 5 is a series of sharper-edged structures common to the exterior of HVAC systems, including delta wings, rectangular wings, delta winglets, and rectangular winglets, including the attendant geometry of each example.

FIG. 6 is a river in a half pipe illustrating laminar water flow.

FIG. 7 is a river in a cylinder, where 71 is the cylinder, 72 is the water surface, 73 are boats floating on the surface of the water, 74 is the boundary layer between the main flow of the river and the bottom of the cylinder, and 75 is the direction of the main flow of the river. The 75 main flow of the river travels between the 72 surface of the water, and the top of the 74 boundary layer—never truly touching the bottom or sides of the cylinder.

FIG. 8 is an example of a rapids, where boulders both on the surface and below the surface disrupt the laminar flow of the river—creating substantial whitewater. The implication is that with multiple changes of direction in the flow of water, the majority of boundary layers disappear and/or are continually disrupted. This is analogous to the idea of how complex structures inside of a pipe or tunnel can disrupt humid air flow and break up the boundary layer along a surface, creating greater condensation overall.

FIG. 9 is a rapids not just in one orientation, but in four orientations. This is analogous to creating complex structures in the four quadrants of the interior of a pipe or tunnel (top, bottom, left, right) to increase overall turbulence in the airflow.

FIG. 10 is an example of “pipe occlusions” wherein the pipe is half blocked at 6 o′clock, then 9 o′clock, then 12 o′clock, then 3 o′clock as you go down the pipe—alternating blockages in order to force humid air into changing direction frequently—a feature which could used in addition to complex micro-structures on the interior of the pipe.

FIG. 11 is an example of how you would increase the maximum surface area inside of a sphere using blades or fins. Wherein the internal surface area of a sphere of 1 meter in diameter would be 3.14 square meters, but when blades of this type are included, the internal surface area can be multiplied many times over depending on the density of the fins.

FIG. 12 is an example of using shavings or curlicues of metal to increase the overall internal surface area of a sphere. The implication here is that you can increase the internal surface area substantially (100× or more) using structures of this type, up to and including things like lightly packed steel wool—which can increase the internal surface area of a sphere by a factor of more than 1000×.

FIG. 13 is an example of densely packed blades inside of a sphere—which is a kind of middle ground between FIG. 11 and FIG. 12—and many of the blades remain in contact with the internal surface of the sphere allowing for thermal transfer.

FIG. 14 is a tunnel with three dimensional iterations of Hokusai's “The Great Wave off Kanagawa” extending from the surface of a tunnel wall—which is a visual example of using fractal geometries to increase overall surface area inside a tunnel.

FIG. 15 is a fractal Koch Curve reimagined as a 3d printed sculpture.

FIG. 16 is another example of a fractal Koch Curve reimagined as a 3d sculpture.

FIG. 17 is a fractal Sierpinski Triangle reimagined as a 3d sculpture.

FIG. 18 is a fractal Peano Curve reimagined as a 3d sculpture.

FIG. 19 is a fractal Menger Sponge in a 3d printed format.

FIG. 20 is a tunnel with an internal checkerboard pattern. Cool how it seems to move, right?

FIG. 21 is an example of the same checkerboard pattern tunnel, but with Menger Sponges spaced evenly on the tunnel's interior surface.

FIG. 22 (upper left image) is a tower made of four Menger Sponges stacked on top of each other. The underlying idea here is—you have a tunnel with already substantial internal surface area. You then place Menger Sponges in stacks onto a pattern like that in FIG. 21, perpendicular to the tunnel surface and reaching toward the centerline. And each successive Menger Sponge which will create additional surface area. At that point you effectively have Menger Sponge towers in a radial pattern (as in FIG. 24) extending toward the center line. Offset that ring of towers clockwise slightly in each “slice” of the tunnel (still maintaining 1 meter spacing) and you end up with what is effectively a maze of substantial surface area that humid air has to travel through. Then take the final step and turn each block in each tower slightly. That way the blocks are slightly offset from each other, with the overall goal of creating complex airflows with those additional edges. In other words, the additional edges create turbulence, and the substantial surface of Menger Sponges condenses as much water as possible. FIG. 22 (upper right image) is an example of “mix and match” fractal structures with a Menger Sponge topped with a Sierpinski Triangle 3d sculpture (a “Sierpinski Pyramid”). In a combination Menger Sponge and Sierpinski Pyramid tower—Sierpinski Pyramids could be welded to the top and all four sides of the top Menger Sponge. In each lower Menger Sponge in the tower, the Sierpinski Pyramids could be added to each of the four sides, supercharging the amount of additional surface area per Menger Sponge tower (FIG. 22 lower image).

FIG. 23 is a fan-like structure built on a variety of fractal models. Air could pass through the structure (if it was bolted to a tunnel wall, for example) and the thicker branches could either be solid metal or hollow. If hollow, geothermally cooled water could feed into the larger branches, more easily maintaining the thermal gradient.

FIG. 24 is a radial pattern which could be used with copper pipes or other structures (such as fins) in a tunnel. The purpose of structures jutting into the interior of the tunnel is to fill the tunnel with as much geothermally cooled surface area as possible. In one embodiment, threaded copper pipes can be screwed directly into the tunnel wall. In another embodiment, the radially aligned elements are flat copper plates or blades covered in microstructures or fractal structures. In each “slice” of the tunnel, these structures could then also be rotated slightly to create “condensation mazes” that humid air must travel through.

FIG. 25 is a drawing of radially aligned copper plates in an imagined tunnel. Condensed water runs down the central channel, and a small maintenance railway runs the length of the tunnel, allowing for easy maintenance of the copper plates.

FIG. 26 is another view of a similar tunnel, where metal plates are arranged in a “window flower box” arrangement, and copper panels are actually quite short (maybe 1 meter in length) so that they can be more easily removed from the tunnel surface for service, cleaning, and maintenance of surface coatings. The small train can have a carrying area for clean plates for replacement and/or to take dirty plates away.

FIG. 27 is a view of copper pipes extending from a tunnel wall. In one embodiment, the pipes are threaded and can be easily removed for cleaning, maintenance, or replacement. In another embodiment, the pipes are solid copper. In a third embodiment, the pipes are hollow and can be fed with geothermally cooled water—with half of the pipe being the “inlet” side, and half the pipe being the “outlet side.” In that embodiment, pipes are split down the middle internally. The pipe would then have a small space at the bottom of the pipe to form a “U” shape inside the pipe. That would allow pressurized geothermally cooled water to enter and exit the pipe in a continuous flow.

FIG. 28 is an example of a vertical orientation of the copper pipes in a “cathedral-like” or “pipe-organ-like” structure. There is a water channel to collect condensed water along the floor, and a small train for the maintenance and replacement of copper pipes.

FIG. 29 is a technical drawing of how FIG. 28 would work, with 2901 being the interior of the tunnel, 2902 being a half-circle water chamber on the top half of the tunnel which feeds geothermally cooled water into copper pipes at 2903. Water exits the 2903 pipes into a half-circle water chamber at 2904. Water then travels from the 2904 chamber down a pipe at 2905 to a pump at 2906 where that water is then pumped through a geothermal loop at 2907. Geothermally cooled water then exits the geothermal loop through a pipe at 2908, which leads to a pump at 2909 which pumps water to a pipe at 2910. The 2910 pipe then enters the upper water chamber at 2911 back into the 2902 upper chamber, completing the cooling cycle. The idea here is to use geothermally cooled water to cool the copper pipes inside the tunnel. Condensation will then form on the surface of the copper pipes. In one embodiment, the outer (ground facing) walls of the 2902 and 2904 chambers are also made of copper. As a result, the geothermal loop could be removed as the outer wall of the tunnel, and both halves of the water 2902 and 2904 chambers, would already be in contact with the geothermally cooled earth surrounding the tunnel, and the geothermal loop would not be needed.

FIG. 30 is a drawing of a traditional farm with a barn, silos, a farmhouse, an outbuilding, and crops planted in rows.

FIG. 31 is a basic design of a “condensation farm” with a free-standing open-air condensation column from the 877 Application (on the left), other silos containing pressurized versions of the 877 systems (in the background), a bottling facility, a water purification system as a generic cylindrical building, and copper pipes buried underground in rows as in the 667 Application claim 1—instead of crops. The copper pipes would be buried 4 ft or more underground to benefit from subsurface temperatures—here the pipes are barely subsurface just for visualization purposes and to provide a comparison to “crops in rows” in an actual farm.

FIG. 32 is a city version of the farm using tunnels (667 Application, claim 2) instead of buried copper pipe (667 Application, claim 1).

FIG. 33 is another version of the city-sized farm with far more tunnels.

FIG. 34 is a methane production spaceship, with a planet with a methane atmosphere at 3401, an umbilical leading from the atmosphere to the ship at 3402, and the methane production ship (cylindrical in shape) at 3403.

FIG. 35 is a cross section and side view of a methane production spaceship. At 3501 you have the external surface of the spaceship. At 3502 you have a liquid hydrogen filled sleeve which cools the surface of the tunnel at 3503. At 3504 you have either blades, fins, or complex fractal structures radiating inwards toward the center point of the tunnel to create additional cooling surface area. At 3505 you have cooling towers and fins exposed to the vacuum of space (−455 degrees Fahrenheit) which would be either connected to the 3501 outer skin of the ship, or directly to the 3503 surface of the tunnel, depending on whether you use a liquid hydrogen filled sleeve or not. In the side view at 3506 you have the exterior of the spaceship (same surface as 3501) which would be populated with 3505 cooling towers and fins. At 3507 you have an umbilical leading downwards into the methane (or other) atmosphere. At 3508 you have a fuel line which leads to a spaceship at 3509 where that spaceship would take on liquid methane, liquid hydrogen, or whatever other fuel is extracted from the atmosphere.

FIG. 36 is a “mountain plain humid air transfer” version of the invention wherein air intakes at sea level at 3601 connect to humid air transfer pipelines at 3602, those transfer pipelines climb the mountainside until they reach sufficiently cool temperatures to condense water consistently on the interior surface of the (likely copper) pipelines year-round at 3603. At that point, you have an iteration of the 667 claim 2 system, which can either be oriented horizontally (with drain holes) or at a slight angle. The pipeline can be exposed directly to the cool mountain air. In another embodiment, that humid air can be ported to 667Application claim 1 or claim 2 (pipes or tunnels) versions of the invention which would be oriented down the mountainside (to take advantage of the gravity energy recoupment aspects of the invention)—and water would condense underground as well. The end result would be hydro power from compressed humid air being pushed up the mountainside. The basic idea here is—mountainsides provide a naturally cooler temperature gradient (similar to and sometimes better than subsurface temperatures) that the invention can take advantage of if humid air is actively pumped to certain altitudes. At that point condensation will happen naturally within the pipeline if the pipeline is exposed to those external temperatures. The interior of the humid air pipeline at that altitude could include complex geometrical structures, fins, and so on to promote condensation. In another embodiment, as a finishing process, the humid air from the pipeline is pumped underground either into 667 claim 1 small bore pipes or a 667 claim 2 large bore tunnels to extract any residual moisture from the air.

FIG. 37 is a series of possible installations for a “condensation park” for kids so they can see what the invention does. The top drawing is of a curved tunnel which would be attached to a copper wall, with a fan at one end. Small drain holes at the bottom of the pipe would constantly drip water. The middle drawing is of a similar installation but using flat copper blades. The bottom drawing is of copper pipes jutting from the copper wall. In each case the flat copper plate holding the tunnel, blades, or pipes (the larger rectangle) would be geothermally cooled. The small tunnel could also include a sleeve or outer layer filled with constantly cycling geothermally cooled water—causing condensation to form both on the inside and outside of the tunnel. The copper blades could be constructed with a geothermally cooled layer of water constantly cycling between two copper plates, and contain a window on the viewer side showing the geothermally cooled water cycling between the plates. The copper pipes in the lower image could also be filled with geothermally cooled water and have transparent endcaps and/or have a small viewing window traveling down the length of the pipe. The various other parts of the invention-pumps, underground geothermal loops, and so on could also have viewing windows to show how they work.

FIG. 38 is a “condensation park” installation with an 877 Application condensation tower covered in fins, blades, and fractal sculptures; a fountain in a radial pattern; and a wall of 10,000 lightbulbs powered by a small hydrogen generator. This installation could also include installations of copper walls with flat blades, a curved tunnel, copper pipes, and visible underground workings as described in FIG. 37. The fun part here for the kids would be the fountain—but another possibility would be the inclusion of a bunker with drones—powered by the hydrogen-fueled generator—which at night or in the evenings could be programmed to do complex light shows. A new show for every day of the year. Or a carousel with horses or some other fun but safe carnival rides surrounding the installation. All powered by water.

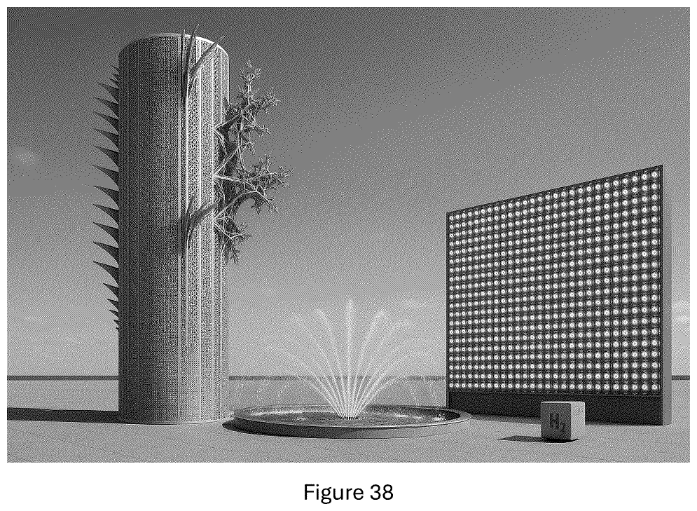

### DETAILED DESCRIPTION OF THE INVENTION

The detailed description of the invention has been largely handled in the 667 and 877 applications, so we will just dive right into the various structural embodiments in terms of the pipe and tunnel geometries, and various possible interior surface coatings. We will follow that with the parameters of some useful embodiments of the invention which are more practical and immediately useful.

In addition, we will provide some possible water output, capital expenditure, and operational expenditure modeling for various potential embodiments of the invention to create a better understanding of what all of this means in economic terms.

### Small Pipe Geometries

One of the simplest improvements to make to the smaller-bore version of the invention (667 Application claim 1) is to use internally threaded copper pipe.²

“The heat transfer efficiency of the heat exchanger and the cost performance of [air conditioners] are greatly related to the inner thread copper tube diameter and geometry of the inner thread copper tube teeth. At the beginning of . . . heat exchanger research, the heat exchanger copper tube diameter was about φ9.52 mm, which was later refined to φ7.0 mm. This fine tube diameter heat exchanger, due to the distance between [being] reduced, [and using fins] to improve efficiency, [caused the] heat transfer effective area [to increase]. As a result [of threading in copper pipe] the flow resistance . . . through the heat exchanger is [also] reduced, and the heat transfer performance of the evaporator coil or condenser coil is strengthened.”³

Meaning that as heat exchanger research has evolved, thinner tubes and external cooling fins attached to those tubes have largely carried the day—aluminum fins like those you see on both the “hot” and “cold” sides of a window air conditioner.

Additionally, some measure of mixing of refrigerant inside of the copper tubes made heat transfer more efficient as refrigerant was constantly being mixed as opposed to staying stagnant and/or allowing boundary layers to form along the interior wall of the refrigerated tube. The simplest way to create that mixing of refrigerant was by changing the interior of the pipe.

There are several types of commonly used threaded pipe: Trapezoidal Internal Thread, M-shaped Internal Thread, and Cross Internal Thread. These are designed for maximizing the utility of various refrigerants (per the article) so are not ideal for this invention.

However, let's extrapolate from that basic system, and turn it inside out. So instead of increasing turbulence to disrupt boundary layers to transfer heat from a refrigerant to an EXTERNAL surface, we will seek to increase overall condensation on an INTERNAL surface instead. To do that, similar elements can be introduced to the interior surface of a condensation pipe or tunnel with surprisingly positive effects.

These elements ideally do three things: 1) maximize surface area for condensation, 2) promote droplet shedding to maintain effective heat transfer, and 3) remain easily manufacturable (e.g., can be machined or extruded in large quantities).

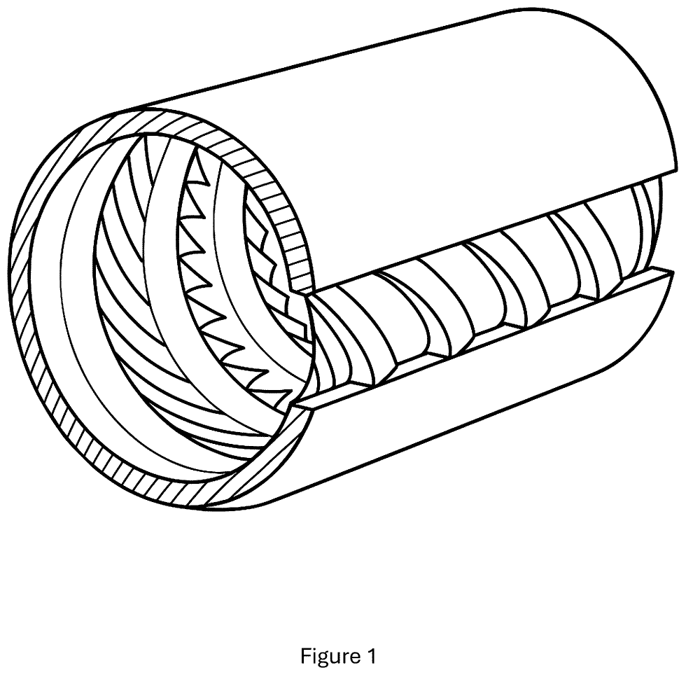

We can then posit several possible internal geometries for the pipe. These could include things like combinations of helical micro-fins and vortex-inducing ridge patterns. FIG. 1.

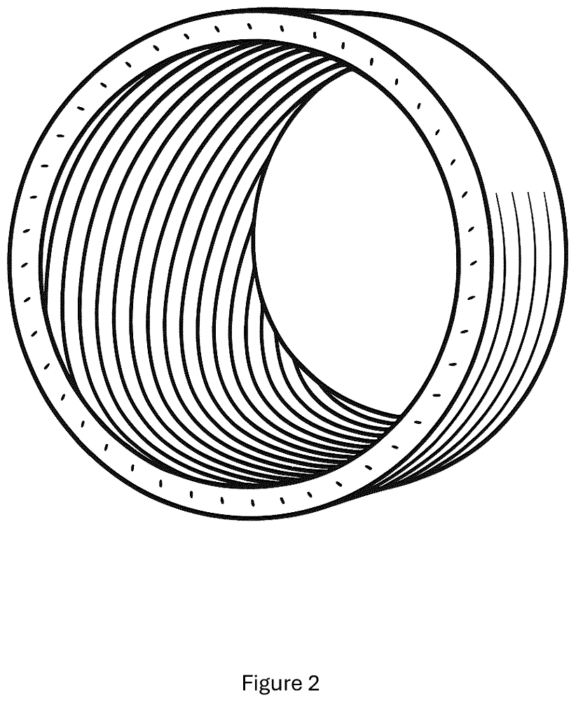

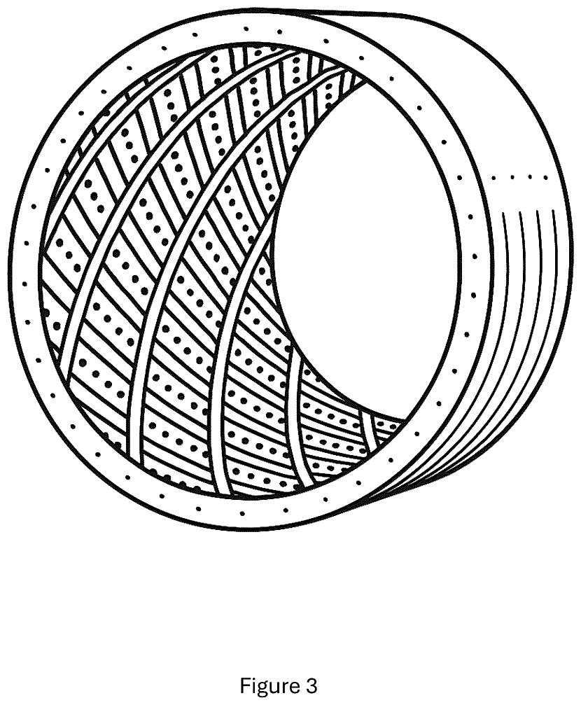

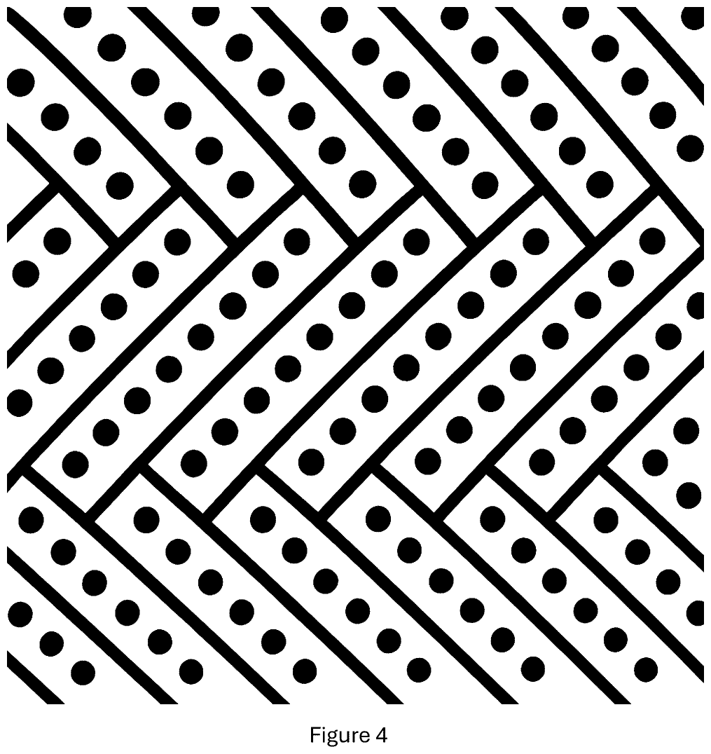

We could also use a hybrid internal geometry combining features from high-performance heat exchanger designs where helical micro-fins spiral along the pipe's inner wall at a shallow angle (e.g.,) 20-40° with a fin pitch ˜2-5 mm; and a fin height ˜0.1-0.3 mm. This increases surface area and induces centrifugal forces in airflow, effectively spinning the air mass like a bullet in a rifled barrel—thinning the boundary layer throughout the pipe length. That turbulence in turn increases local heat transfer, which for our purposes would aid in condensation. FIG. 2. Another possible configuration would be small dimples or riblets arranged perpendicular to fin crests in a staggered or chevron pattern with a diameter/depth ˜0.5-1.0 mm, spaced at ˜1-2 diameters apart. This would generate substantially more disruption of the surface airflow, and eliminate most laminar pockets. FIG. 3 and FIG. 4.

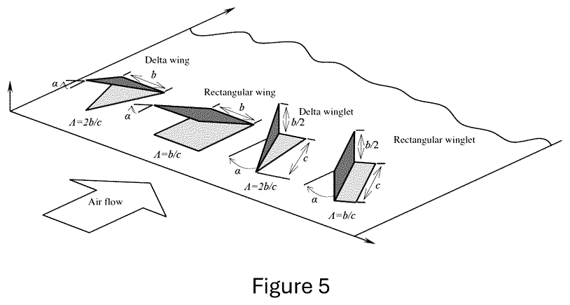

Another possibility is to incorporate triangular or sawtooth fins where sharper edges promote turbulence and enhanced mixing of the airflow. Some examples used EXTERNALLY in heat transfer systems include delta wings, rectangular wings, delta winglets, and rectangular winglets. Those same types of structures can be put inside of pipes INTERNALLY to create additional turbulence. Same structures, different use. FIG. 5.

Turbulence improvements in these cases prevent areas of stagnant humid air, and in turn keep the surface temperature gradient as high as possible.

So the effect here is that internal surfaces, ridges, bumps, and larger structures (such as fins) disrupt laminar airflow inside of a copper pipe and at the same time increase overall surface area. Think first of a smooth pipe, and then of thousands of protrusions in various orientations inside of that pipe. Each of those variations means more turbulence, as well as more potential sites (and surface area) for condensation to occur along a pipe's interior.

Given that the invention (in both the 667 and 877 embodiments) is usually oriented either at a steep angle or is completely vertical, droplets are removed by gravitational forces more effectively when there is no stable boundary layer. A boundary layer acts as a weak force holding condensed water in place.

What this means is that modification of the internal geometry of the pipe itself in the small bore and tunnel versions in Application 667; or modification of the external surfaces of a condensation tower (open air or siloed) in the 877 application—can increase water production substantially.

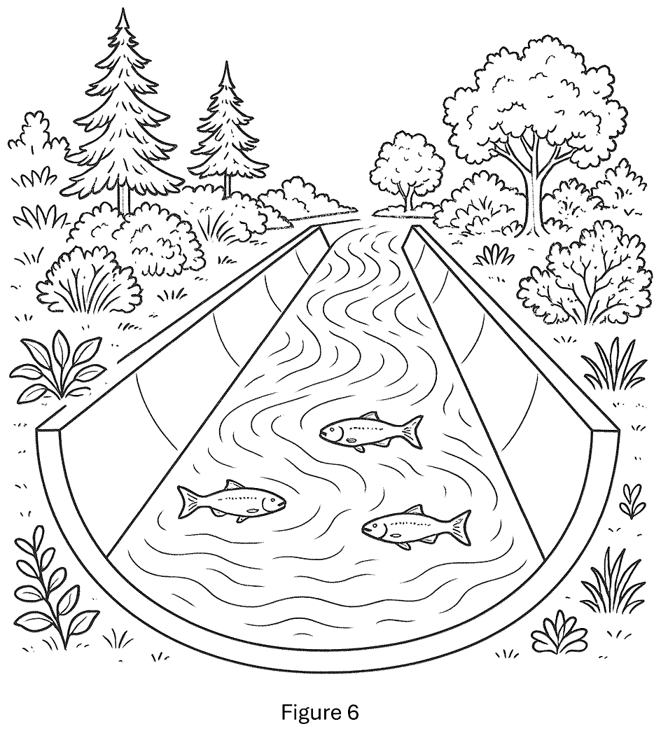

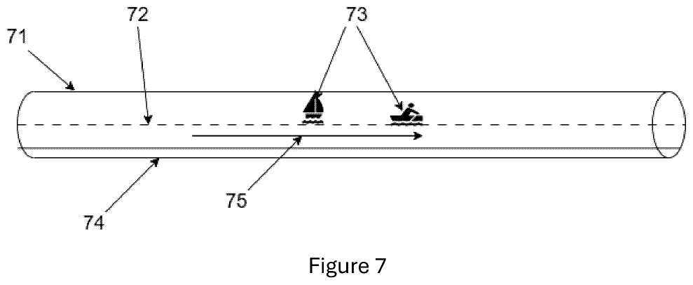

You can think of the disruptions to laminar flow across a condensation surface kind of like boulders in a river. If water was to travel down a smooth river in the form of a half-pipe (FIG. 6) boundary layers would form along the surface of the half-pipe and there would be very little disruption of the main flow of the river. Water would flow down the main channel, and the main flow the river would never truly touch the bottom of the river due to the boundary layer—Item 74 in FIG. 7.

An understanding of boundary layers can also be seen visually in the video about the Tesla Turbine in the footnote⁴ at timecode 4:18.

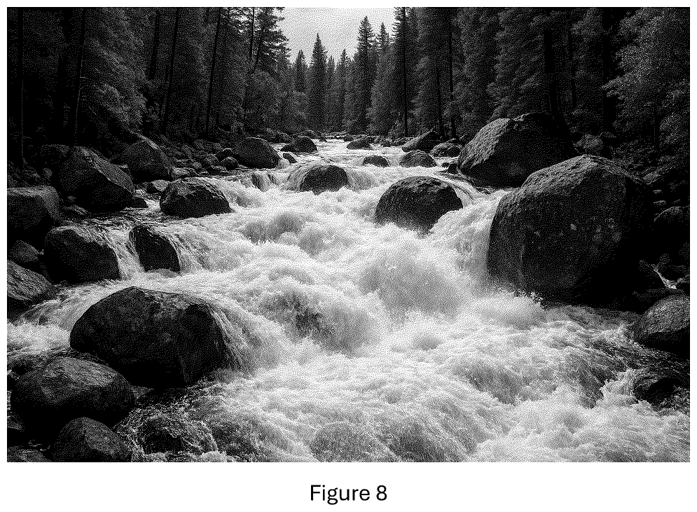

However, in a rapids, with many boulders, and rock protrusions, and trapped logs, water is typically churned into “whitewater”—where the geometry of the boulders, stones, logs, and other protrusions causes significant mixing and the elimination of the majority of boundary layers. Trout can still hide in the eddies behind boulders, but the main flow of the river is completely disrupted by the rapids as water is pushed in multiple directions simultaneously. Meaning that consistent boundary layers, particularly in the more chaotic areas of the rapids, simply cannot form. FIG. 8.

What we are discussing here is a similar concept, except we are dealing with humid air (which is invisible) and seeking to extract as much moisture from it as possible as it travels—not down a half-pipe river, but rather down a full pipe cylinder.

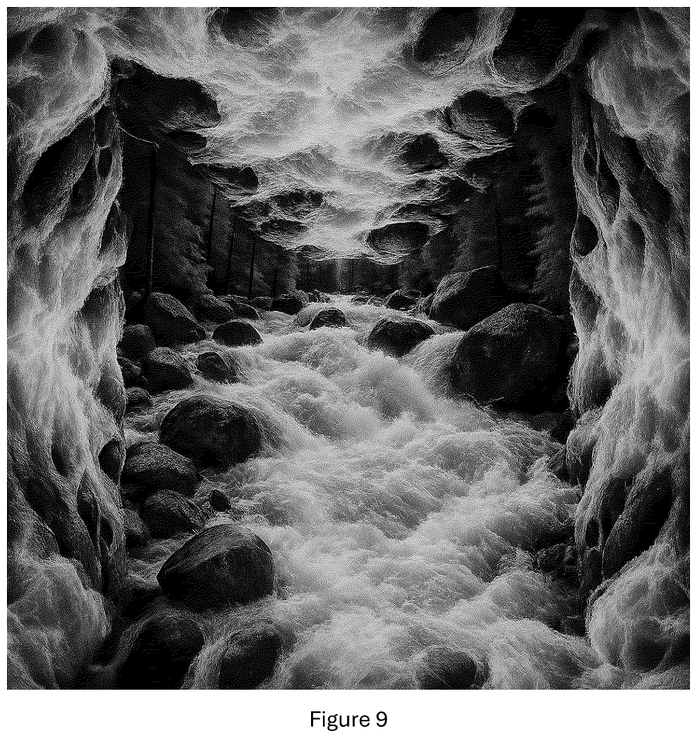

Conceptually, it's like two rivers in two separate half pipes—one inverted on top of the other. Or like four rivers—one at 6 o′clock, one at 9 o′clock, one at 12 o′clock and one at 3 o′clock. And ideally, the flow of each “river” of humid air is interrupted or disrupted via a “riverbed” strewn with “boulders” of a variety of geometries creating the maximum amount of turbulence. FIG. 9.

So, a chaotic internal structure for the pipe—and as chaotic as possible—is actually of great advantage in attempting to achieve maximum condensation. This has not been done before because most HVAC systems, as well as most condensation systems, seek to condense water on the OUTSIDE of condensing pipes.

And HVAC systems are trying to do that condensation work in very small spaces—like the space occupied by your typical window air conditioner. So larger scale protrusions don't make sense on the INTERIOR of the pipe. In that configuration, the overall flow of refrigerant is more important than creating internal surface areas for maximum heat transfer.

In other words, most complex structures in current refrigeration and HVAC systems happen on the OUTSIDE of the pipe—like the complex multitude of aluminum fins attached to the pipes of your window air conditioner.

So in the different configurations of pipe geometries discussed here, humid air enters the pipe, but in order to navigate the “maze” of the pipe's internal construction, it must navigate a “rapids” of many thousands of possible surfaces—getting bounced around from the top of the pipe to bottom and back again, and then from side to side and into all kinds of nooks and crannies (all providing additional surface area “traps” for condensation)—all the way down the pipe—until each unit of humid air has shed as much of its water as is physically possible.

Highly complex internal configurations of smaller bore pipes (1-4 inches) are difficult to achieve unless they are included at the time of extrusion. In other words, the interior of most copper pipes is too narrow for complex post-facto internal surface modification. Larger pipe configurations and tunnels can have highly complex internal geometries however (see large-tunnel discussion below).

Additional configurations beyond those mentioned here can be included in future pipe geometries and/or as extrusion methods. Additionally, as 3d-printing of metals becomes more commonplace, pipes can then be further optimized and contain more complex-or multi-layered geometries.

With all of these improvements, the overall goal is the same: ideal internal pipe geometries geared towards the maximum condensation of water.

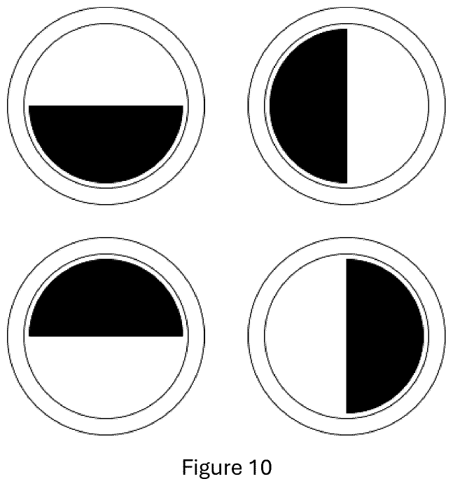

Some additional possible configurations include small diamond-shaped blades, half-pipe occlusions or flat blades which block half the pipe and force air to change direction frequently as it travels down the pipe (think a half-pipe barrier at 6 o′clock, then at 3 o′clock, then at 12 o′clock, and then at 9 o′clock as you go down the pipe). FIG. 10.

You can also add swirl patterns, microtubules oriented both horizontally and vertically (similar to a Gorilla Grip bathmat⁵ or the footbeds of Adidas Adisage Slide sandals⁶) along the pipe, as well as helical or curlicue “dropdowns” which allow airflow but create a significant increase in the overall condensing surface area. Kind of like stalactites from a cave ceiling which partially occlude the cave's interior—and those stalactites are always dripping water.

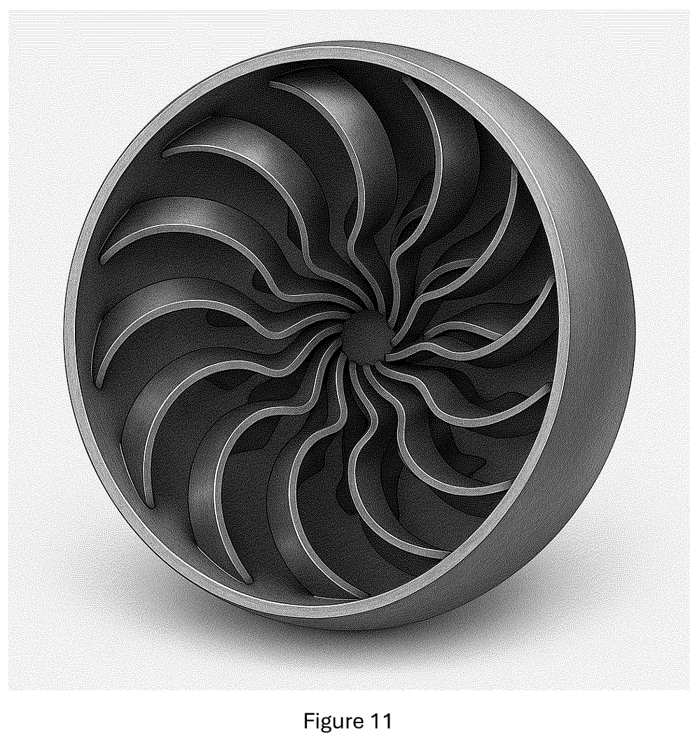

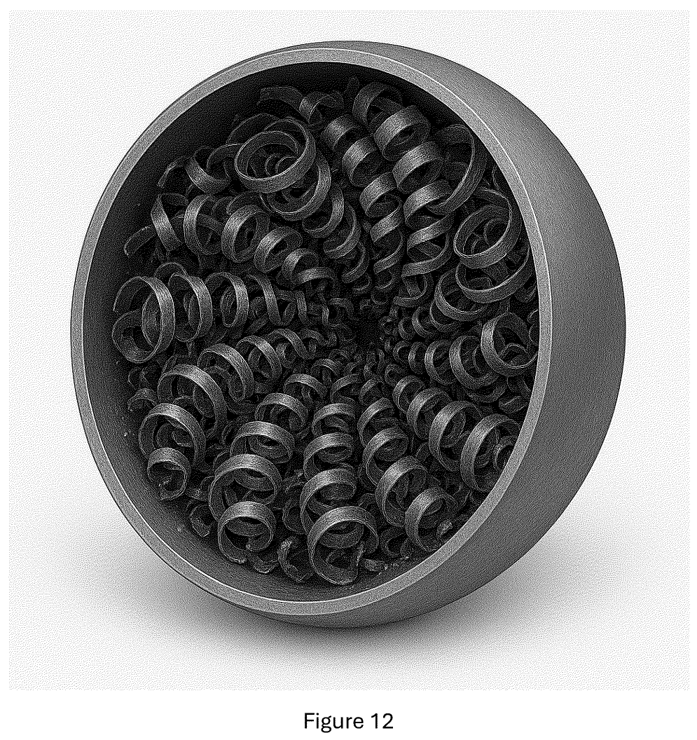

The general idea is the same as if you wanted to increase the maximum surface area on the interior of a sphere. You could do it through fins or blades as in FIG. 11, or you could do it through shavings or curlicues as in FIG. 12.

In those scenarios, the increase in the internal surface area would be in line with the following numbers—for a 1-meter diameter sphere:

| Configuration | Estimated Internal Surface Area | |
|---|---|---|
| Smooth Sphere | 3.14 | m² |
| Blades (max-packed) | ~421.6 | m² |
| Steel Wool (10% vol) | ~4,190 | m² |

“Curlicue shavings” of something like steel (or copper) wool packing a 1-meter sphere (or tube in our case) is probably not a viable option for this project. It would be difficult to maintain a constant temperature of that steel wool as the majority of the steel wool wouldn't be touching the geothermally cooled surface of the walls—and as a result no consistent geothermal cooling transfer gradient could occur.

However, the max-packed “internal blades” configuration (a 134× increase over the internal surface area of the base sphere) does provide some interesting possibilities in terms of applying similar geometries to the interior of a pipe.

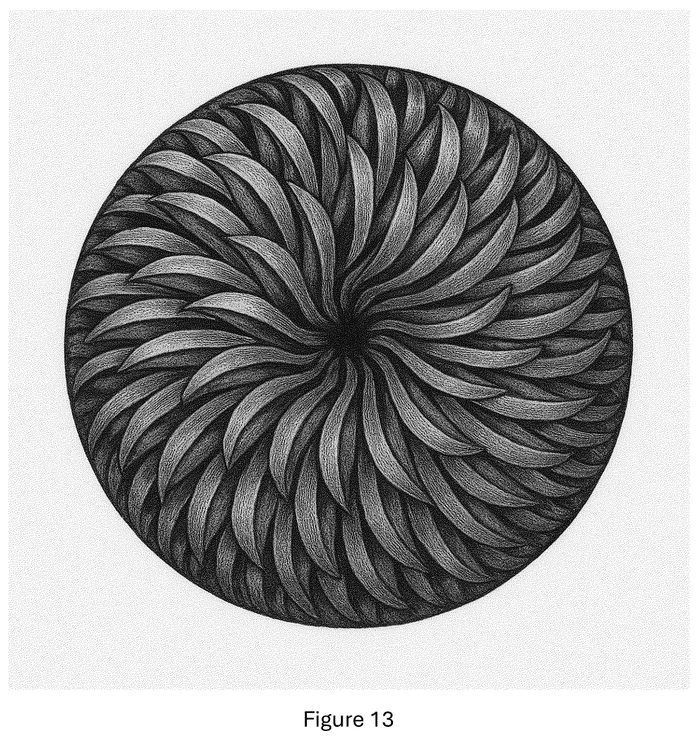

Ideally, you'd want to get close to something like FIG. 13—where the internal surface area of the sphere (or tube in our case) is increased above 100×. Which again is probably not practical as air needs to reach all of the blades in order for condensation to form; and an ideal air mass for the invention is one that is sent down a tube or tunnel in sufficient quantity and in a perfect ratio of dwell time and velocity. So too many blades will block air flow. Too few would reduce overall condensation. Too much airflow creates backpressure; too little airflow reduces condensation. But there is likely a perfect happy medium between the number of protrusions and turbulence enhancers, the maximum amount of airflow you can force down a tube or tunnel, and the dwell time required to promote maximum condensation. I don't know what that perfect configuration is—I only can suggest that it does exist—and then provide some of the possible tools that will get you there. s

But achieving that “perfect balance” would be the eventual long-term goal—pipes filled with these kinds of structures creating maximum chaos in the airflow (from the discussion of pipe surfaces above), and the maximum possible surface area for condensation. And all the while the blades, fins, or other structures remain in contact with the walls so that thermal transfer would occur between the geothermally cooled wall and blades or more complex structures—see below.

The exact geometries aren't important at this juncture for the small-bore version of the pipe. There just isn't that much you can do with small-pipe internal geometries in that limited space. But the conceptual framework is useful for the discussion of larger tunnels below.

In the simplest of terms, the more stuff you have in the pipe or tunnel disrupting the airflow—the more surface area. And more surface area plus more chaotic airflow means more condensation.

### Internal Pipe Coatings

A variety of hydrophilic internal pipe coatings can also be used to increase the overall amount of condensation forming on the interior surface of a copper pipe.

Some advantages of hydrophilic coatings include enhanced nucleation as hydrophilic surfaces lower the contact angle of water vapor, encouraging earlier and more frequent droplet formation. This in turn increases the number of condensation sites.

Typically, these coatings are used on the EXTERNAL surfaces of HVAC systems—including air conditioner fins. If you've ever seen an air conditioner with “blue fins”—that is a type of aluminum foil treated with a hydrophilic layer. That hydrophilic aluminum foil is then bonded to the aluminum fins.

The main advantage of hydrophilic surfaces is thin-film condensation where condensation occurs primarily in the form of a thin, continuous film instead of isolated droplets (dropwise).

Dropwise condensation offers high local heat transfer, but thin-film condensation combined with turbulent airflows and rapid water film drainage (another advantage of hydrophilic surfaces) maximizes sustained condensation performance over time.

We experience this all the time when we sweat—when we need to dump a little heat—our sweat beads. But when we are running a race, and need to drop heat consistently, sweat “pours down” our skin in a sheet—maximizing heat transfer away from the body and into the air (if we are moving) and into clothing and/or down-and-away from locations where we need to cool off.

It's why, when we sweat, we typically “wipe away” excess sweat. But we don't do it with a towel. We spread out the beaded sweat into a sheet with our hand. And what we're really doing is creating a thin film coating which takes heat transfer to the next level. And spreading that sweat (which contains a small amount of oil) essentially creates the same kind of hydrophilic surface. Sweat doesn't stick to us—it runs. The droplets of sweat are coming from inside the body, but that form of thin film-wise condensation (or evaporation in cooling) carries heat away from the body as rapidly as possible.

What we're doing in the pipes and tunnels is kind of the reverse of that—creating surface areas that are geothermally cooled—and therefore “sweat” condensation. A hydrophilic layer makes that “sweat” (condensation) into a consistent “sheet of water” on the geothermally cooled interior surfaces of the pipe or tunnel maximizing “sweat” (condensation) production.

A sheet of water (sweat) on the surface of the skin evaporates more quickly in drier air. We are just reversing that process by taking humid air and forcing water from it.

Hydrophilic surfaces maintain even liquid coverage, minimizing dry zones that could act as thermal insulators.

When combined with micro-fins, dimples, and other complex geometries, a hydrophilic layer ensures better water distribution, prevents stagnant water pooling, and when combined with chaotic air disrupts the boundary layer more consistently.

For purposes of the invention, graphene oxide films, titanium dioxide (TiO₂), zinc oxide (ZnO) nano coatings, and super hydrophilic silica are some of the best options.

Compared to bare copper, hydrophilic coatings can increase condensation rates by 30-80%.

### Large Tunnel Improvements

So we can at the outset adopt hydrophilic coatings from the previous section not only for the small-bore version of the invention, but also immediately and on a far grander scale for the larger tunnel (667 Application, claim 2) system.

Additionally, unlike the smaller bore pipe versions of the invention, the larger spaces inside a tunnel mean a variety of additional complex geometries are possible.

The internal surface of copper in the tunnel version of the invention can also be scored and grooved much as above-both at the macro and micro-level.

Meaning that the internal surface of the tunnel can effectively be “corrugated” or incorporate many of the possible configurations of complex geometry above—but at much larger scales.

In other words, a 29-foot diameter tunnel has a lot of interior space. So, what do we fill it with?

One possibility is that you could theoretically end up with a kind of “fractal” system where larger iterations of fractal geometries could cover the entire interior surface of the walls, and those fractal geometries would in turn repeat down to a much smaller micro level.

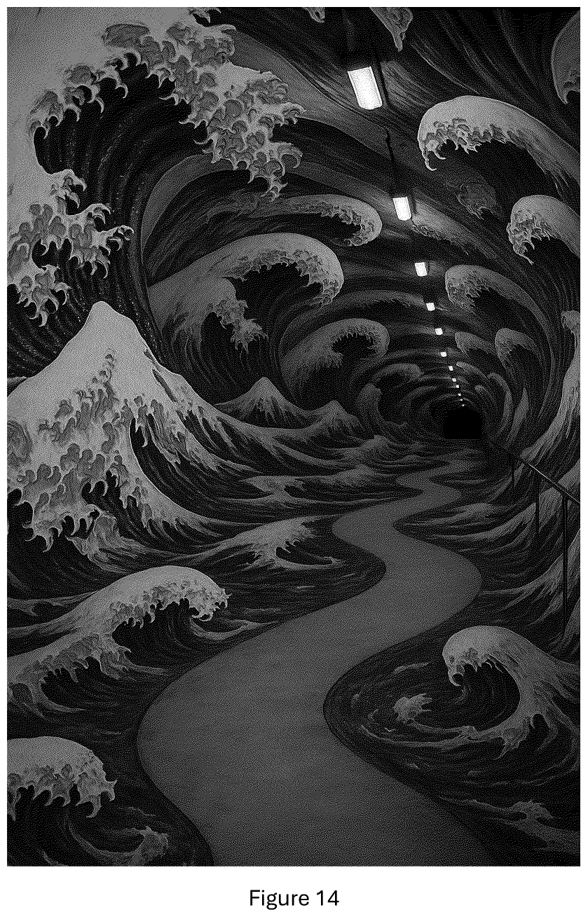

Conceptually, it's a bit like using Hokusai's fractal wave in “The Great Wave off of Kanagawa”—but in three dimensions along the floor, ceiling, and each side of the tunnel. See FIG. 14.

Fractal structures could increase the internal surface area of a tunnel far beyond what smooth or even micro-finned surfaces could provide.

The additional surface area of complex fractal structures—provided the majority of that surface area can be maintained at geothermally-cooled temperatures—can provide far, far more surface area than a smooth tunnel alone.

In a one-kilometer-long tunnel the geometry of fractal structures could create micro-sites for condensation numbering in the hundreds of millions.

Even small changes to geometry using fractals can make a big difference. A Koch curve-like fin or ridge along the pipe wall, for example, will have more total edge length (and as a result more surface area) than a regular triangular fin.

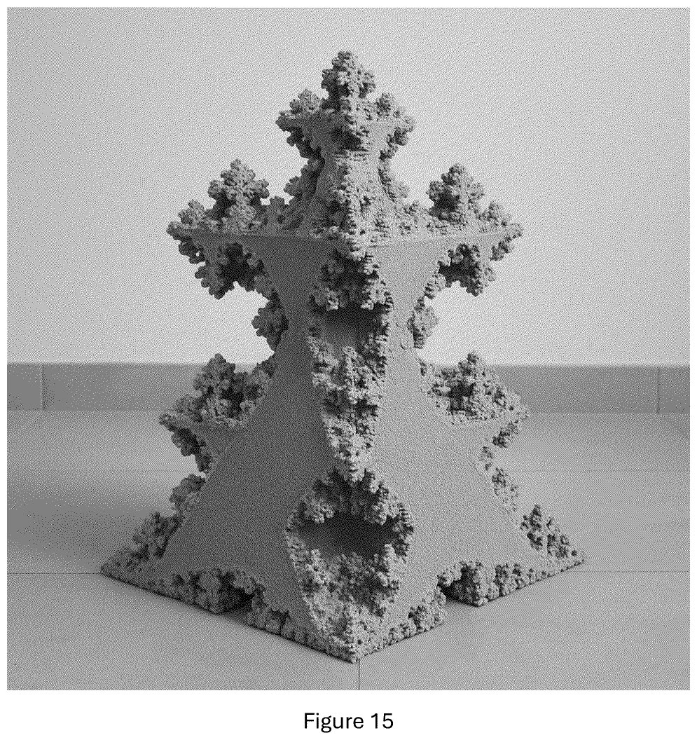

Using Koch or other fractal geometries such as Sierpinski Triangles, Cantor Sets, Menger Sponges, and Peano Curves—not just in two dimensions as turbulence generators along the wall surface, but in clusters or 3d-printable wall extensions—could create substantial surface area in small amounts of space. See FIGS. 15-18.

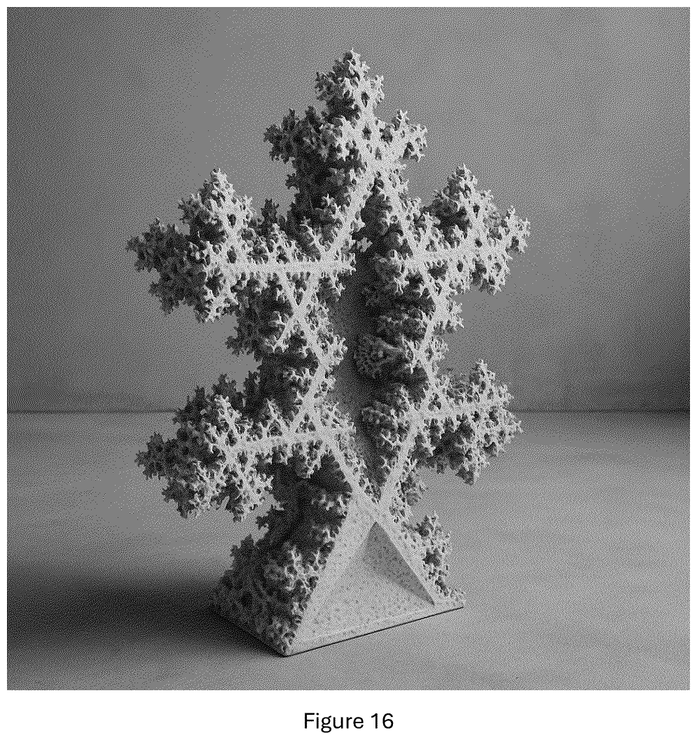

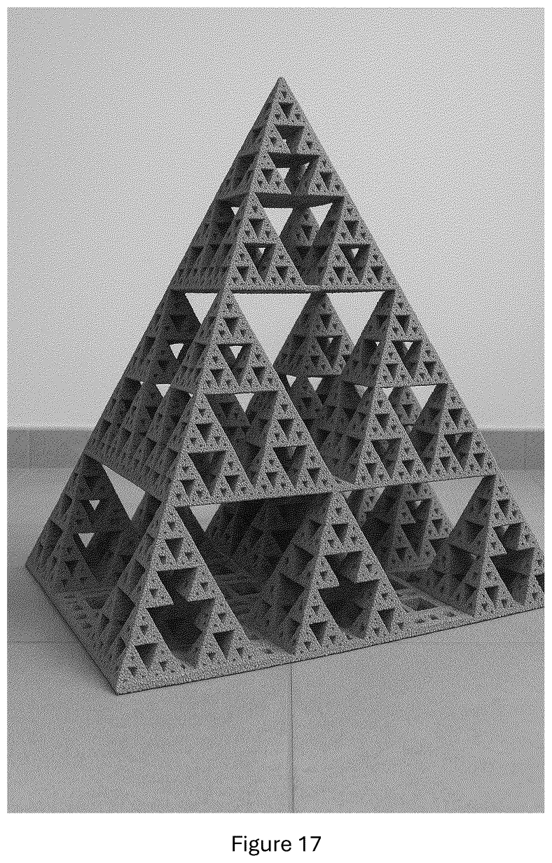

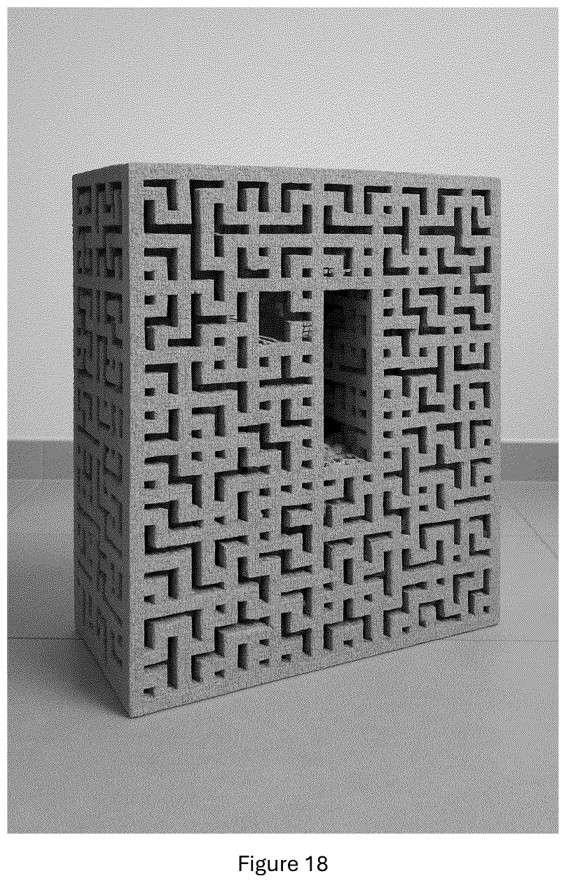

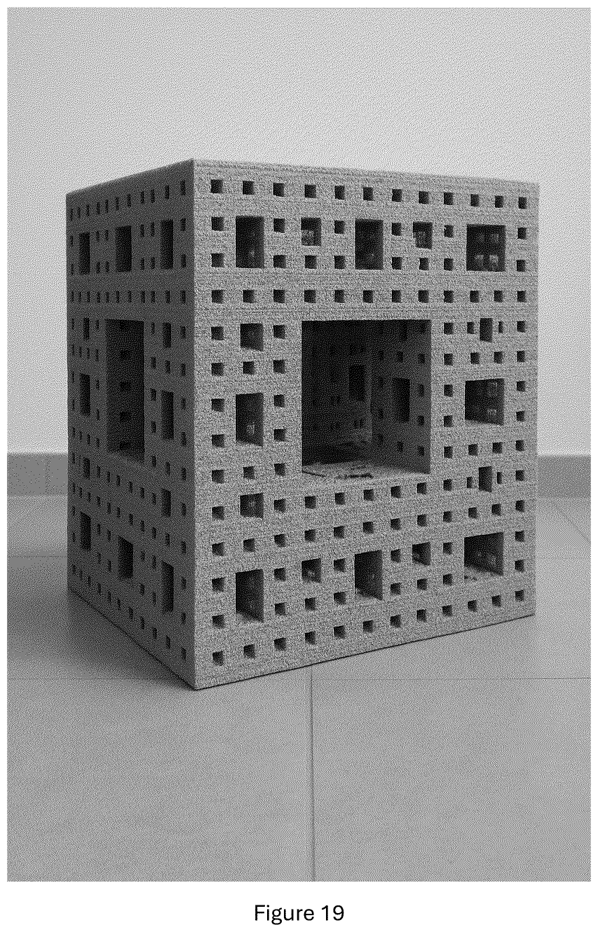

To review from the “Brief Discussion of the Drawings” section, FIG. 15 is a Koch Curve reimagined as a 3d sculpture. FIG. 16 is another Koch Curve reimagined as a 3d printed sculpture. FIG. 17 is Sierpinski Triangle set reimagined as a 3d sculpture. FIG. 18 is a Peano Curve reimagined as a 3d sculpture. And FIG. 19 is a Menger Sponge as a 1 cubic meter 3d sculpture.

One of the more practical fractal formations would be a Menger Sponge as it is essentially a cube and therefore easily stackable and/or reconfigurable. FIG. 19.

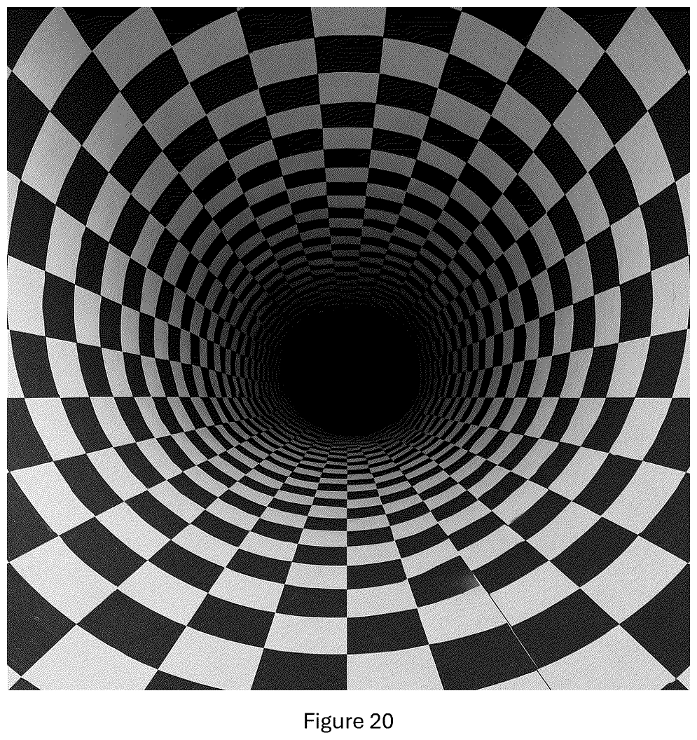

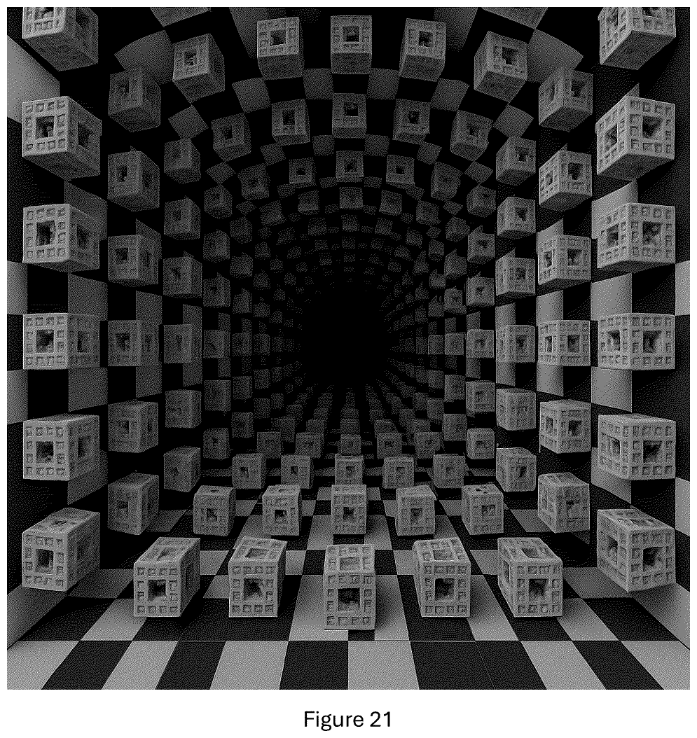

The idea there would be to create a checkerboard pattern inside of a tunnel—FIG. 20. And then put Menger sponges on all of the “black squares” of the checkerboard. FIG. 21.

This would create sufficient airflow between each sponge, the sponges would disrupt airflow both at the macro and micro level, you would have a much greater surface area for condensation, and the Menger Sponges would be easy to remove, clean, and stack into taller towers.

For each cubic meter of air, the surface area of a plain cube is 6 meters—i.e. each cube has 6 faces, one meter square.

At Iteration 4, a 1-meter cubed Menger Sponge has a total surface area of 146.39 square meters.

Iteration 4 is at the limits of current machinability, but at Iteration 6 a Menger Sponge has a total surface area of 723.57 square meters. And again, that is per cubic meter.

But even at Iteration 4, in a tunnel 1-kilometer long and 29 feet wide, if you put Menger Sponges in checkerboard grids (leaving 1 meter on each side for airflow) you could fit 3,085 of them along the interior surface of the tunnel. FIG. 21.

So at iteration 4, that's 3,085×146.3 square meters or 451,335.5 square meters of potential condensing surface area.

In that same tunnel if you stacked the sponges in towers radiating inwards towards the centerline, you could create Menger Sponge towers 4 meters tall (or 4 sponges) high.

That's 12,340 sponges×146.3 square meters of surface area, or 1,805,342 square meters of surface area. Which is a whopping big amount of surface area in a tunnel only 1 kilometer long.

Even at more easily machinable iterations (Iteration 2 or 3) the use of Menger Sponges still represents a substantial increase in overall surface area inside a tunnel.

The value of using Menger Sponges here is twofold.

First, if you rotate each “slice” of the tunnel filled with Menger Sponge towers slightly, as you go down the tunnel, you end up creating a “maze” of towers which will break up laminar airflow and increase overall condensation.

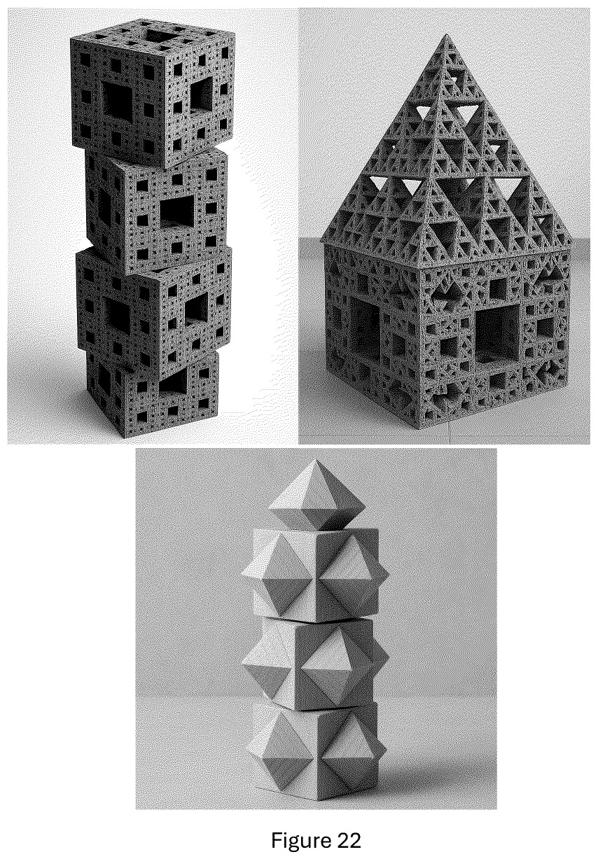

Secondly, by tuning the angles of the components of a Menger Sponge tower for maximum turbulence—simply by slightly rotating each level of the tower—you can increase the complexity of the airflow (creating additional condensation via disruption of boundary layers) with very simple adjustments. FIG. 22 top left.

You can also mix and match fractal sculptures, as in FIG. 22's top right drawing, where you have a Menger Sponge with a Sierpinski Triangle sculpture (a “Sierpinski Pyramid”) on top. Add a similar Sierpinski Pyramid to each of the four faces of a Menger Sponge, and you have created a substantial amount of additional surface area beyond the Menger Sponge tower—simply by taking advantage of additional “free space” inside the tunnel.

In other words, if you place Sierpinski Pyramids on each face of the four sides of each Menger Sponge in a Menger Sponge Tower (and add one pyramid at the top of the tower) and you've effectively added (at Iteration 5 for the Sierpinski Pyramids) an additional 40 square meters of surface area. Per pyramid! FIG. 22 bottom image.

Which means each tower would have (4 Menger Sponges×146.3 square meters)+(4 sides×4 Sierpinski Pyramids×40 square meters)+40 square meters (for the Sierpinski Pyramid topper)=585.2+640+40=1,265.2 square meters of surface area per tower. At 3,085 towers per 1-kilometer long tunnel, that's 3,903,142 square meters of surface area, more or less.

Basically, with the addition of structures like Menger Sponges, Menger Sponge towers, Sierpinski Pyramids, or other fractal geometries to the basic 677 claim 2 system, you can create substantial additional surface area, turbulence, and condensation inside of a tunnel.

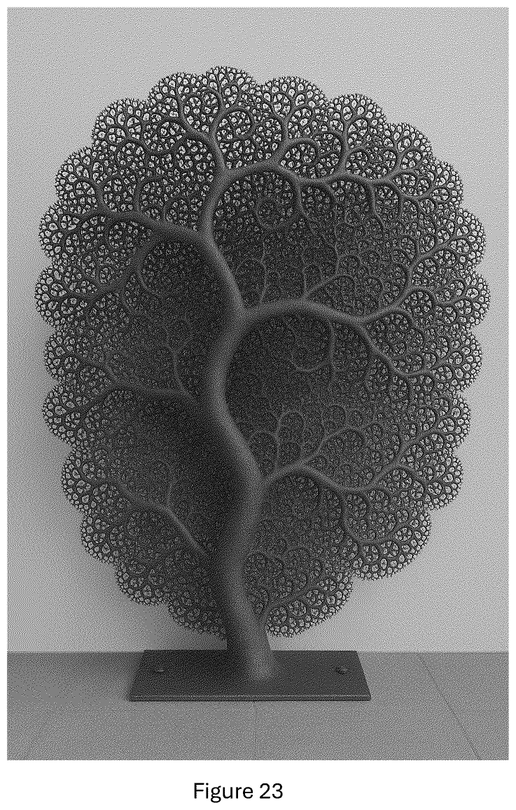

Another possibility is a “tree-like” or “fan-like” fractal structure bolted to the wall of the tunnel. Humid air would travel through the structure much like wind through the strings of a tennis racket. Since that fan-like structure is bolted to the geothermally cooled wall, it would maintain a thermal gradient. FIG. 23.

Those fan-like structures could also be fed with geothermally cooled water (if the larger branches were hollow) in order to maintain a more consistent temperature of the smaller elements.

So here, in this embodiment, tunnels are lined with a variety of tree-branch-like fins of different sizes and in different orientations. The main branch splits into smaller branches, then smaller sub-branches mimicking vascular or dendritic patterns. The analogy here is of the structure of a lung—which takes in air, provides substantial surface area in a very small amount of space, and absorbs oxygen and exhales carbon dioxide all in one go. Here we're doing something similar-providing the maximum cooled surface area to humid air so that it can dump its oxygen equivalent (water) onto the branches of the pattern.

All of different types of fractal structures above would be like boulders in a rapids—but where those boulders have been tuned to create the maximum amount of whitewater.

In theory anyway, these additions to the tunnel wall surface could be 3d printed, bolted to the walls, taken down periodically for cleaning, and then replaced in sequence—creating a consistently “clean” surface area for condensation.

Complex fractal wall protrusion “sculptures” could be easily cleaned by full immersion in cleaning solutions to remove scale, deposits, and other matter from even the smallest nooks and crannies; and then dipped in a secondary solution to reapply hydrophilic surface layers.

While not entirely there yet, 3d printing of copper is now possible into complex shapes.⁷ It may also be possible in future years to force-grow copper crystals using high potential directed electrochemical deposition.

Electrochemical deposition is an entire field of study not worth going into at length here—but suffice to say that it may one day may be possible to grow complex copper lattices naturally (with microscopic level complexity) as opposed to 3d printing them.

To summarize, fractal patterns can be used to create large amounts of surface area inside of a tunnel, while at the same time creating turbulence and consistently disrupting boundary layers.

And the ideal configuration is probably not just a single structure like the Menger Sponge tower—but multiple fractal geometries all working in concert. The overall math above is with 1-meter cubed Menger Sponges, but the overall tunnel space could be filled with far smaller Menger Sponges or other structures—creating a vast grid of multiple geometries maximizing surface area for condensation while at the same time creating a potentially “perfect” airflow for condensation.

In other words, the internal geometry of pipes or tunnels can be as, or more, important to condensation as the basic version of the invention (a smooth-bore pipe or tunnel).

### Other Possible Internal Tunnel Structures

Following from the above, not only can the internal surface of the larger bore tunnel be optimized in terms of its surface geometry and surface coatings, but we could also fill the internal empty area of the tunnel with simpler types of structures.

The embodiments above describe fractal bolt-on sculptures which extend into the interior of the tunnel like mathematical stalactites and stalagmites, all the while maintaining contact with the geothermally cooled tunnel surface of the tunnel.

However, considering some additional possible tunnel configurations, in some embodiments, the tunnel is 3.8 meters wide—a Boring Company tunnel which would necessitate smaller structures.

In another embodiment the TBM (Tunnel Boring Machines) used in the England-to-France “Chunnel” construction are used, creating an 8.8 meter (29 feet) wide tunnel.

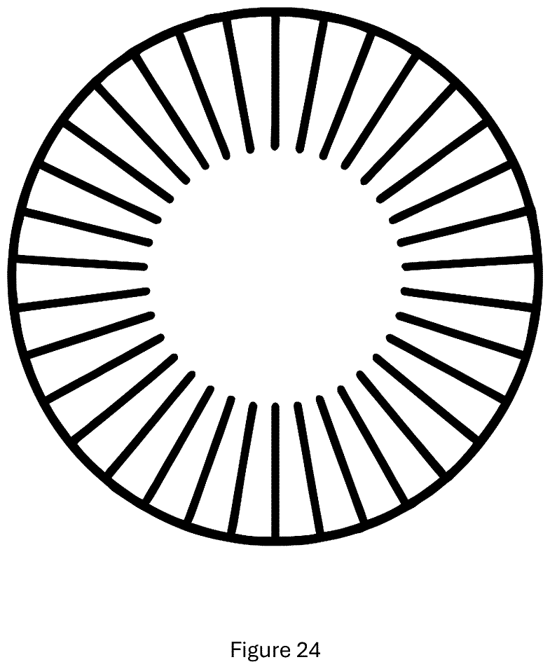

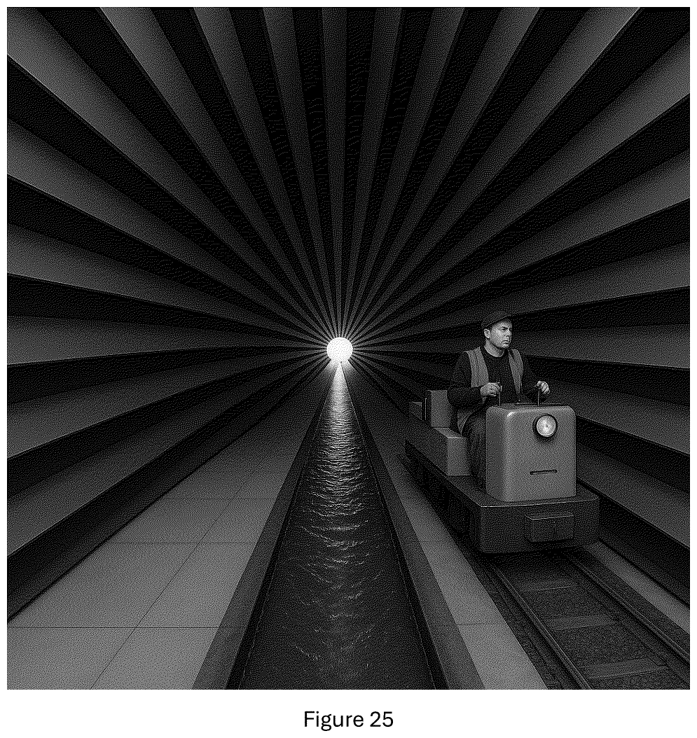

In the larger embodiment, instead of fractal sculptures, the tunnel might be filled with simple copper fins extending perpendicularly inwards from the tunnel wall towards the centerline and oriented parallel to the tunnel direction. FIG. 24. In one embodiment, those fins would extend down the entirety of the tunnel, with a small railway/service area at the side for easy maintenance. FIG. 25.

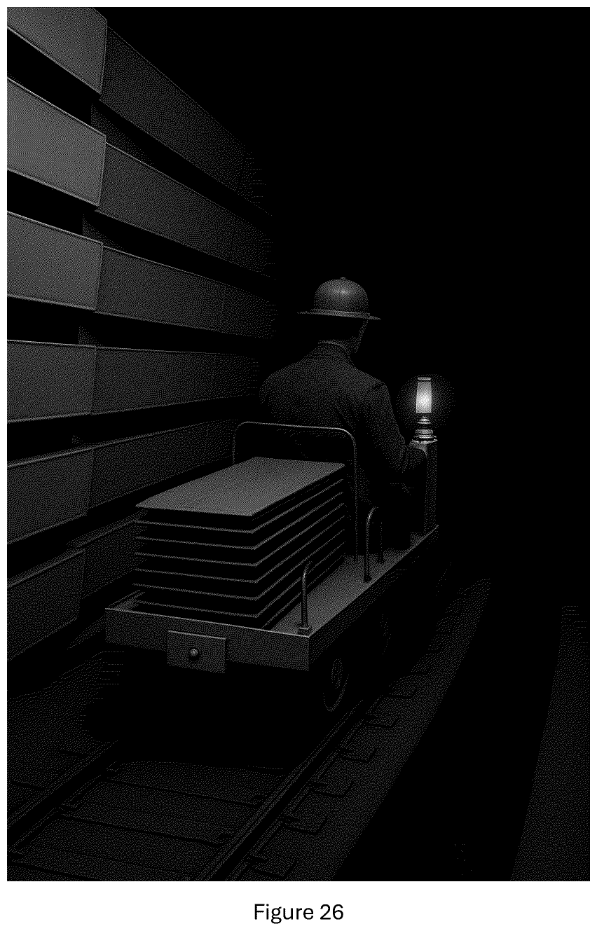

In another embodiment, an operator could drive the train down the tunnel, each copper panel would be approximately 1 meter in length and be connected via brackets to the tunnel wall in a “window flower box” arrangement. FIG. 26.

As mentioned above, thermal paste (similar to that used in computer chip cooling in desktop PCs) or thermally conductive pads could be applied to the mating surface between the copper plate and the tunnel wall increasing contact area and thermal transfer.

In that manner, the operator could replace copper fins in small batches to minimize downtime, as well as remove dirty blades, replace them with clean ones, and perform maintenance, cleaning, and reapplication of hydrophilic surfaces at a facility outside the tunnel.

In both the smaller and larger tunnel embodiments, those fins might be replaced with either vertical copper pipes, or with radially arranged copper pipes.

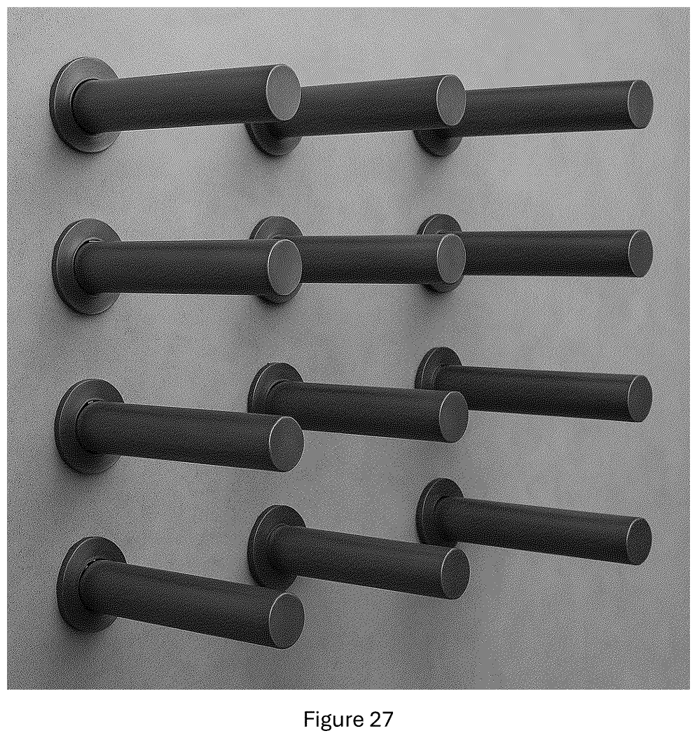

In the latter version, the radially arranged pipes (in a pattern like that in FIG. 24) can be inserted into the wall with threaded screws. Those pipes could be either solid copper—or tubes filled with geothermally cooled water. The threaded screws would allow for easy removal and maintenance. If hollow copper tubes were split down the middle with an internal copper barrier with a small space at the end creating a “U” inside of the pipe—a pump could push water down half of the pipe and force it up the other half—meaning the pipe would stay a steady 55 degrees Fahrenheit from geothermally cooled water. FIG. 27.

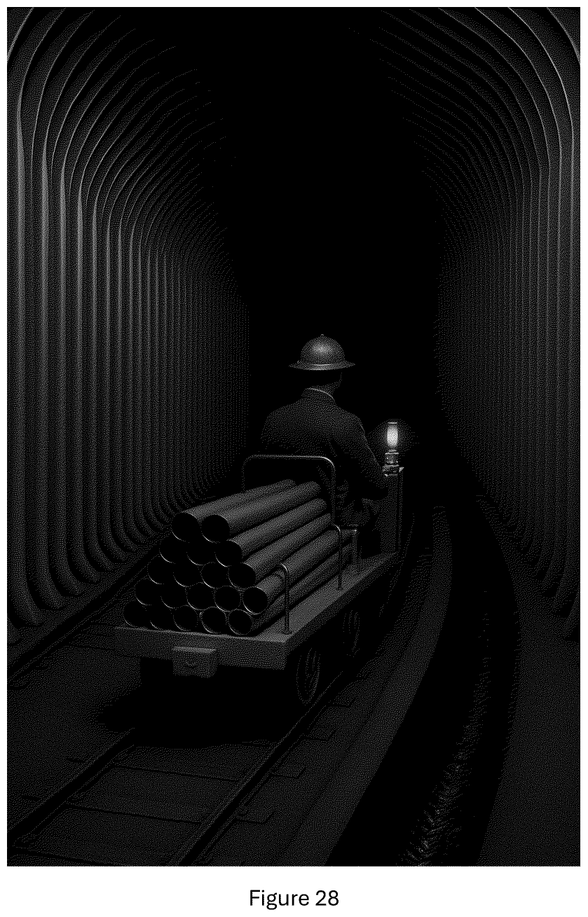

In a vertical copper pipe embodiment, or “cathedral” or “pipe organ” arrangement, geothermally cooled water running through the pipes filling the interior of the tunnel could also be directed to a geothermal system, which would then send that water down the copper pipes from the top of the tunnel towards the bottom of the tunnel. FIG. 28.

In that iteration, water exiting pipes at the bottom of the tunnel would be rerouted through a geothermal loop and then be sent to the top half of the pipe to cycle through the pipes again.

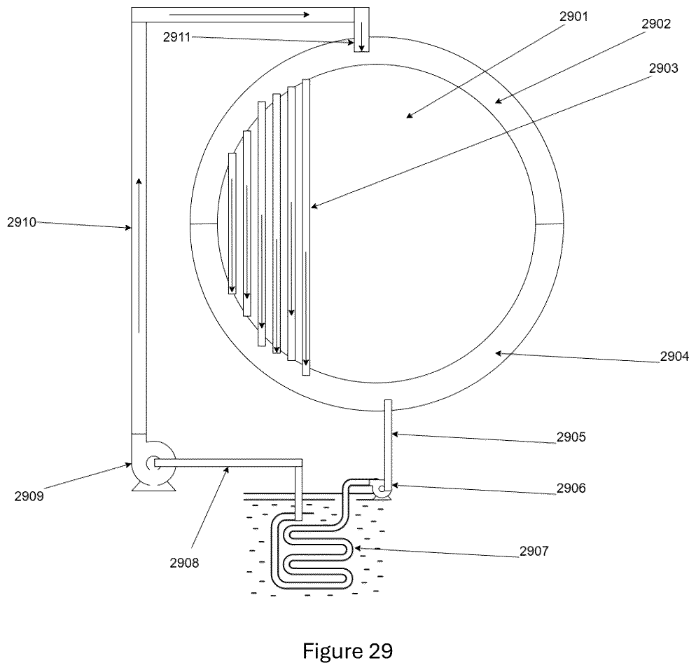

Ideally, geothermally water systems used to cool the pipes in the tunnel in that arrangement would be modular in nature—servicing maybe 10-50 meters of tunnel at a time—with appropriate pumps to do the work of moving water through the system. FIG. 29.

This is analogous to the 877 application, except instead of one single large cylinder in the middle of the tunnel cooled by geothermally cooled water, you have a plurality of copper pipes stretching from floor to ceiling. Just like pipes in a cathedral organ. But the underlying principle of using geothermally cooled water to cool an element inside of a tunnel to produce condensation is the same.

### The Format of a Condensation Farm

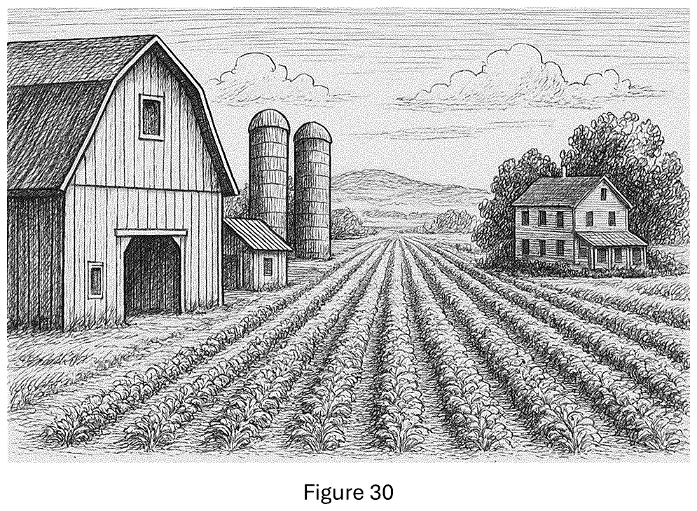

Everyone knows what a traditional farm looks like—a barn, silos, outbuildings, and rows of crops. FIG. 30.

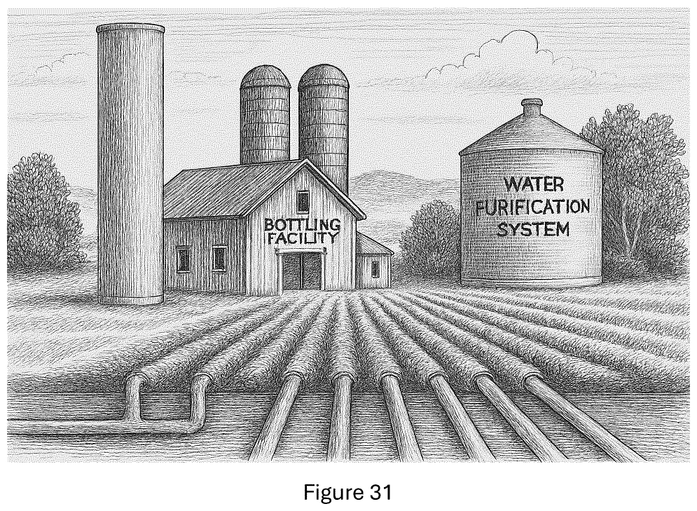

But what if instead of traditional crops, the farm was a “condensation farm” with a bottling facility instead of a barn, a water purification system instead of grain storage, a column-based open-air condenser as described in the 877 Application instead of a silo, “pressure sleeve” versions from the 877 Application as other silos, and rows of copper pipes buried underground instead of rows of crops? FIG. 31.

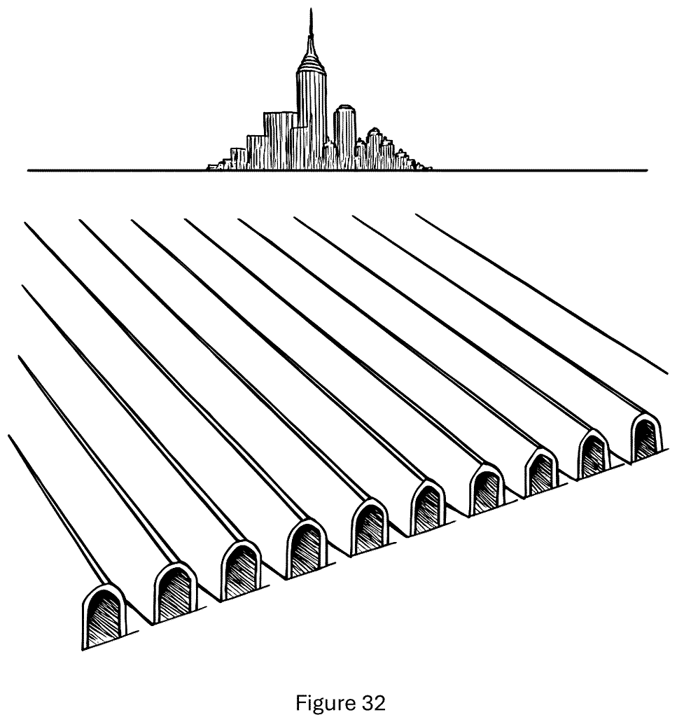

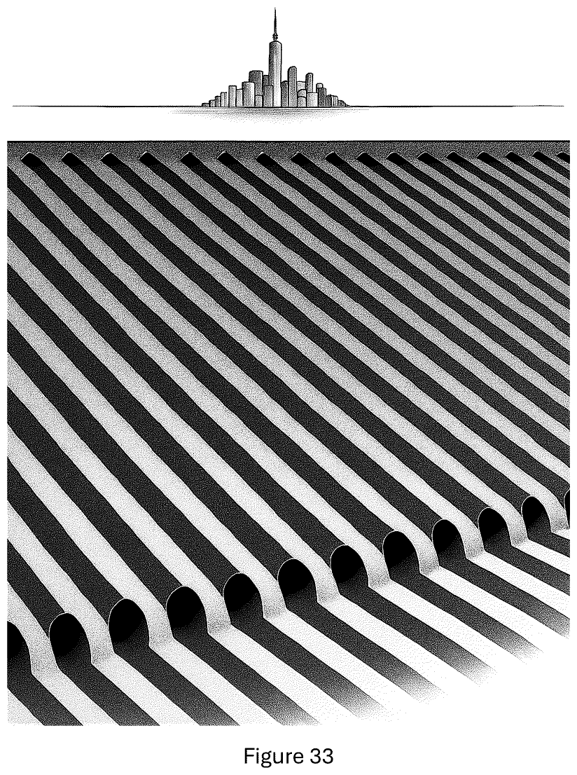

And then if you took a municipality or city and used the larger scale tunnel version, instead of hundreds of parallel copper lines—you would have hundreds of iterations of the tunnel version beneath the city. FIG. 32 and FIG. 33.

Many of the pieces of that puzzle—from pumps, water purification systems, to bottling lines, to water sampling and testing, are known and are specialized fields which are not worth going into here as they are not patentable.

What is innovative here is the 667 application claim 1 and claim 2, the 877 iterations, and then drawing all of these elements together first into a small scale (1+acre) condensation farm using buried copper piping and/or open air or pressure sleeved silos. And then applying those same principles of a “condensation farm” to massive city-scale farms using larger tunnels.

The scale is different in the two iterations, but the basic form is the same—massively parallel rows of crops—except the crops are no longer traditional crops. The crop is now singular: water.

It is this inventor's hope that millions, if not billions of people will take up the profession of “water farming”—whether with small scale condensation farms as individuals or families, or in larger tunnel formats for use in industry, regional water management, agriculture, or electrolyzation of water into hydrogen for power generation and transportation.

With all of those farms—at both the large scale and the small, our world truly will once again become a paradise.

Climate Change will be a thing of the past. Enough food can be grown for everyone, everywhere, without having to stress our oceans, or aquifers, or rivers.

It is a world where everyone can have enough food to eat, and water to drink, and it is a world where there is energy to spare.

The invention here, in many ways, in both the 667 and 877 iterations, is very simple. The potential impact of the invention is not. A different world awaits us. Hopefully, we will have the courage to embrace it.

### Ship Based or Dirigible Based Designs

One final iteration of the invention is to take 667 claim 2—and place the tunnel in a cylindrical ship in space. And to use the same structure used here to condense water—and use it to instead condense a wide variety of chemicals.

For example, if a ship sat in the upper reaches of the atmosphere of a planet with a primarily methane atmosphere, that ship could send vast amounts of that methane through a similar tunnel structure. If the surface of that tunnel (filled with Menger Sponges or other structures) was cold enough, that atmospheric methane would condense into liquid methane, which in turn could be used for rocket fuel or reaction mass.

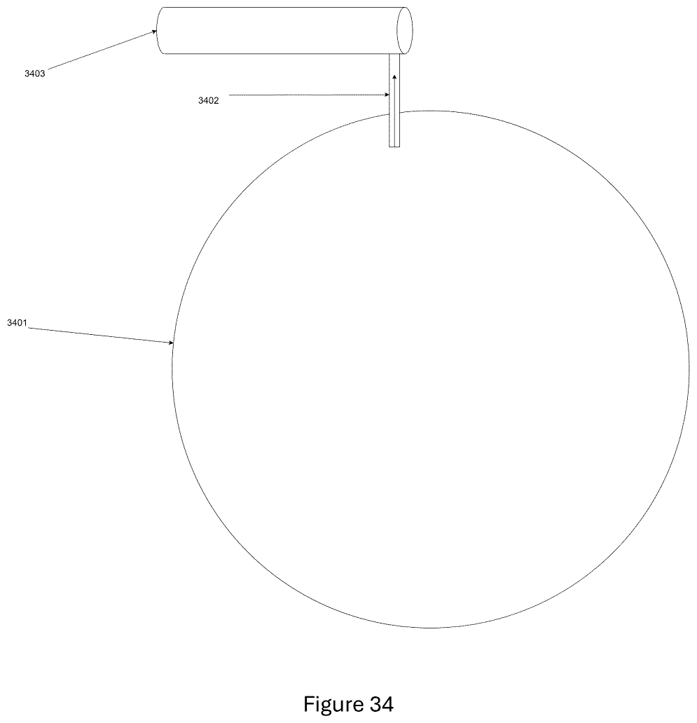

For example, if a cylindrical ship 20 kilometers long sat at the edge of the atmosphere of Jupiter, Uranus, Saturn, or Titan—it could collect massive amounts of methane using umbilicals. FIG. 34.

Those umbilicals could feed the tunnel in the central core of the ship.

The ship could be powered by solar energy, or via the methane which it collects.

In a vacuum, objects in the dark will eventually radiate away their heat to −455 degrees Fahrenheit. The International Space Station, for example, requires a complex system of insulation and thermal management which includes radiating excess heat into space.

Methane condenses at −258.7 degrees Fahrenheit. The thermal gradient difference between the −455 degrees Fahrenheit of the vacuum of space and the −258.7degrees Fahrenheit “dew point” of methane—is 196.3 degrees Fahrenheit.

The 667 claim 1 and claim 2 inventions rely on a very narrow thermal gradient (usually less than 20 degrees Fahrenheit) between humid air and geothermal temperatures to condense water. The same principle applies here, except we have a 196.3-degree thermal gradient to work with.

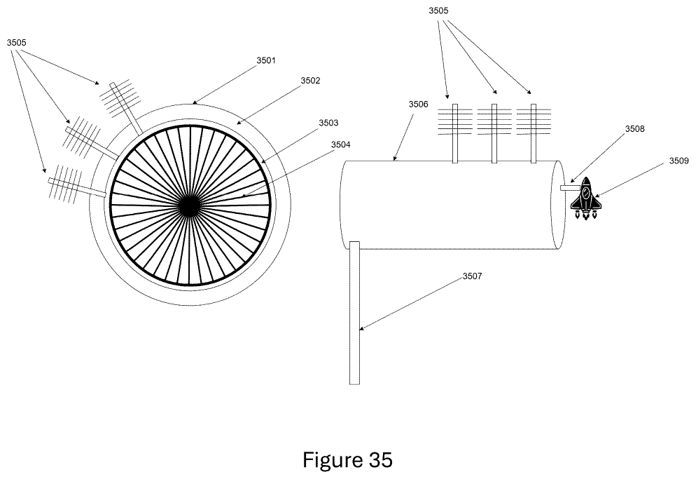

In one embodiment, the ship would be covered with heat sink “towers.” Those towers would be connected to the tunnel surface. The interior of the tunnel inside the ship would be filled with fins, fractal structures, or other structures oriented toward the center point of the tunnel. As methane condensed on those surfaces, the heat sink towers on the exterior of the ship would wick away any excess heat from that process. In other words, the 667 claim 1 and claim 2 versions of the invention use the Earth as the refrigeration method. Here we are using the vacuum of space as the refrigeration method instead. FIG. 35.

In another embodiment, the internal tunnel would be surrounded by a sleeve filled with liquid hydrogen. The internal cylinder would spin, creating gravity along the surface of the tunnel. And the thermal gradient between liquid hydrogen (boiling point of −423.2 degrees Fahrenheit) and methane's condensation point of −258.7 degrees Fahrenheit would be 164.5 degrees. Allowing for methane condensation with a slightly gentler gradient.

Liquid hydrogen could be produced on board the ship via methane pyrolysis, which causes methane to decompose into hydrogen and pure carbon. Hydrogen in that case could be cooled to, and maintained in, its liquid state quite simply through porting it close to the exterior surface of the ship.

Large bore iterations of this invention in ship form—are essentially large fuel depots just waiting to happen. So on some future day—large multi-kilometer cylindrical ships could orbit the planets mentioned above, cycle those planets' atmosphere into their central core, and create an unlimited supply of rocket fuel or reaction mass for spaceships.

If the methane production ships spun at a sufficient velocity (creating gravity) gaseous methane would enter the central cylinder at one end, travel the length of the cylinder, condense on the vacuum-cooled interior surface and/or complex fractal geometrical arrangement, and create an unending source of liquid methane.

Ships could then dock with the methane production ship and refuel. Which means that Mankind could then zoom around the solar system quite comfortably forever (and for free).

In this embodiment, gravity can also be manipulated to increase methane production. If the internal cylinder is rotated, gravity would pull methane condensing in the tunnel towards the tunnel wall.

In very practical terms, if you had a ship that was 20 kilometers long, and 5 kilometers wide, and you spun the internal cylinder at 0.598 RPM that would create 1 gravity at the tunnel surface. To produce greater condensation, you would increase the spin.

So if you had 1.25 gravities at the tunnel surface, that would require 0.67 RPM. At 75% of the distance toward the center point, gravity would still be ˜0.312 g—meaning that methane would condense on the internal structures and fall toward the tunnel surface where it could be collected.

When greater condensation is desired, the spin of the ship's internal sleeve could be increased to multiple gravities. Creating 2 gravities at the tunnel surface for instance, would require a spin of 0.847 RPM (which isn't an enormous increase in speed from 1 gravity) and would greatly increase the flow of condensation (provided you could pump enough methane gas into the system to make that gravity increase worthwhile).

As an aside, you can also manipulate gravity to increase water production in both the small bore (claim 1) and tunnel versions (claim 2) of the 667 invention—if you spin the tunnel or pipe like the spin cycle of your washing machine.

What that does is increase the rate of flow of water away from condensing surfaces by pulling water towards the tunnel wall. Meaning (theoretically) in that embodiment, more humid air can be handled by the system. Add micro holes along the surface of the spinning pipe or tunnel—and that's like the holes in a washing machine during the final spin. Water will travel through those holes where it can be collected.

So even that simple addition is worthwhile—not only in space, but (in certain configurations) here on Earth as well. A kind of “rock tumbler” water production tunnel (or methane collection spaceship)—using artificial gravity to increase overall production over time. Cool, right?

Similar designs could be used in dirigibles in Earth's atmosphere, using temperature gradients between surface and atmospheric temperatures. At 35,000 feet temperatures are −55 degrees Fahrenheit. But even at far lower altitudes, those are useful temperature gradients which could be explored. Think a dirigible above the coast of California or Japan, dangling umbilicals downward to collect humid air, using cooler ambient temperatures at altitude to power condensation, and having a second tube that sends water down from the dirigible to the surface—where it could generate electricity at the bottom end. A man-made cloud. With directed rainfall.

More practically, pumping massive amounts of air from humid coastal valleys, or near the ocean, to the peaks of mountains—gets you to the same place.

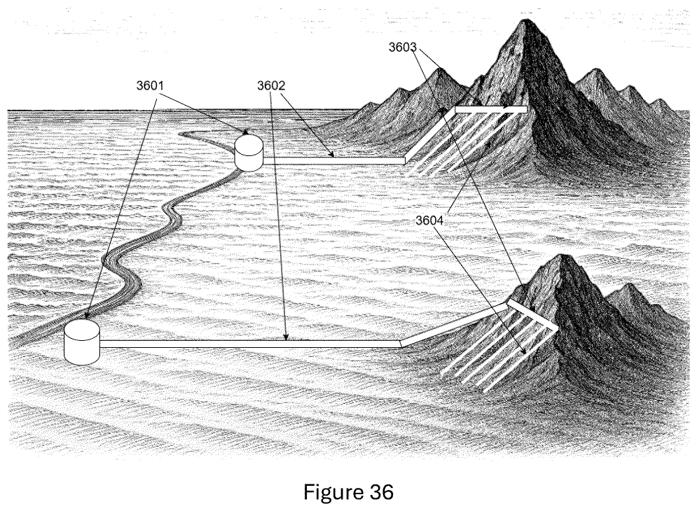

Meaning massive amounts of humid air pumped from the coast of California to places like the top of Mount Whitney, which during the year has a mean daily maximum temp of 37.5 F and a mean daily minimum of 14.4 F—means that iterations of the 667 invention (with appropriate thermal management to bring the interior of the pipes or tunnels to just above freezing in all seasons)—could result in SUBSTANTIAL water production. FIG. 36.

The point of the above discussion is—whether within Earth's atmosphere, or in space, thermal gradients are our friends. In other words, subsurface temperatures used in the production of water—are just the beginning.

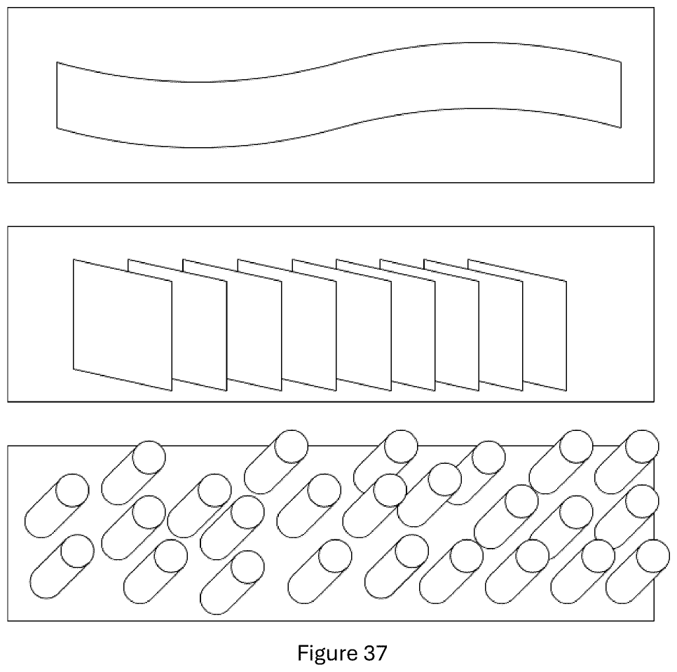

One final thing you can add to the invention is sculptures based on the design which would be fun for kids learning about the system. Those might include a free-standing copper plate with an attached curved tunnel—FIG. 37 top drawing. Or flat plates or blades arranged along a copper wall—FIG. 37 middle drawing. Or copper tubes jutting from the surface of a wall—FIG. 37 bottom drawing. In each of those three cases, the copper wall and/or structure would be geothermally cooled, and in humid weather would create condensation. One iteration of the installation would include a condensation tower from the 877 Application, covered with blades, fins, microstructures and fractal sculptures—to illustrate what the interior of tunnels in the system look like. And along with that, a bubbler to drink from, a fountain in a radial pattern, and a wall of ten thousand lightbulbs powered by hydrogen gas and a small electrical generator, a bunker filled with drones that could do light shows—a new one for every day of the year —and carnival rides including a carousel, tilt-a-whirl and others—all illustrative of an unending supply of water—for all future generations.

The kids will probably say “who cares about all of this stuff—let's go on the RIDES!” But the lesson will lodge in there somewhere (especially because of the rides or drone shows) and maybe one kid will see how it all works together, and at some later date become an engineer . . . or an inventor—and come up with something even better.

### Water Output and Economics

In the following section I will run through a few possible configurations for a smaller-scale condensation farm, provide some hard numbers for optimizing the larger tunnel version, and provide some probable build-out costs as well as likely water production numbers and costs per gallon for both.

For example, here is a Bill of Materials for a 1-acre condensation farm.

Hanson Water Fann - Bill of Materials

| Item | Quantity | | Unit Cost (Estimate) | Total Cost (Range) | Notes |
|---|---|---|---|---|---|
| Smooth Copper Pipe (2 [symbol] × 100 ft) | 100 | trenches | $250-$400 | $25K-$40K | Main conduit for condensate flow |
| Axial Fans (25 CFM) | 200 | units | $80-$130 | $16K-$26K | Two per trench, solar-compatible |
| Fan Mount Kits | 100 | kits | $40-$60 | $4K-$6K | Brackets, guards, screws |
| Arduino (ESP32 or equiv) | 5 | units | $25-$40 | $125-$200 | Central controller for sensor logic |
| Moisture/RH Sensors | 100+ | units | $7-$12 | $700-$1,200 | Ambient trench monitoring |
| Flow Meter (Inline) | 2 | units | $90-$150 | $180-$300 | Reservoir and kiosk flow tracking |
| Solenoid Valve (¼″ diverter) | 1 | unit | $25-$50 | $25-$50 | Sampling diversion per fill event |
| Sampling Reservoir (Insulated) | 1 | unit | $450-$850 | $450-$850 | Composite sample tank |
| RO Purification System | 1 | skid | $12K-$25K | $12K-$25K | Includes UV + remineralization |
| Sediment & Carbon Filters | 2-3 | units | $40-$80 | $80-$240 | Pre-RO filtration |
| Solar Panels (50 W) | 100 | panels | $50-$90 | $5K-$9K | PV array for trench + RO power |
| LiFePO4 Batteries (10 Ah) | 100 | units | $80-$100 | $SK-$10K | Energy storage for night ops |
| Charge Controller + Inverter | 2 | sets | $250-$400 | $500-$800 | Solar power management |
| Water Kiosk (RFID/dispense) | 1 | unit | $8K-$15K | $8K-$15K | User interface, meter, secure housing |
| Low-Pressure Pump | 1-2 | units | $400-$700 | $400-$1.4K | Reservoir to kiosk |
| TDS, pH & Temp Sensors | 2-4 | units | $60-$110 | $120-$440 | Quality tracking pre/post RO |
| Monitoring Display (Optional) | 1 | unit | $250-$600 | $250-$600 | Dashboard or kiosk screen |

| | | | | |
|---|---|---|---|---|
| Gravel/Trenching Material | Bulk | — | $30K-$80K | Excavation, base, labor |
| Plumbing/Wiring Consumables | Bulk | — | $5K-$10K | Pipe connectors, cable runs |

[symbol]

indicates data missing or illegible when filed

That creates a Capital Expenditure (CapEx) of $168K-$377K, depending on trench depth, purification choice, and local labor.

The annual operating expenses would be in line with the following:

Annual Operating Expenses (OPEX)

| Category | Estimated Annual | Cost Notes |
|---|---|---|
| Fan Maintenance + Replacement | ~$2,000 | Bearings, motor service, occasional replacements |
| RO Filter + Membrane Changes | ~$1,500 | Includes sediment, carbon, and RO membrane lifecycle |
| Sensor Calibration & Upkeep | ~$750 | Includes moisture sensors, TDS, pH, and temp sensors |
| Nanopore Coating Reapplication | ~$2,000 | Skip If you're not using nanopore sleeves |
| Battery Health & Solar Cleaning | ~$1,000 | Panel cleaning + battery longevity monitoring |
| Labor (Sampling + Klosk Servicing) | ~$2,500 | Weekly cleanouts, refill tracking, basic QA sampling |
| Insurance & Misc. | ~$250-$500 | Covers equipment loss, general liability |

Or about $10,000.

Also note that this installation is completely off-grid and relies only on solar power and battery backups. Small amounts of energy (during rainy or cloudy seasons in some areas) can be added to the system from the grid at a relatively minimal cost. The cost remains minimal—because the refrigeration (handled by geothermal cooling) is entirely free.

The basic version of the farm described here uses only smooth bore copper pipe—before any improvements to pipe geometry or the addition of hydrophilic surface coatings.

In economic terms, over a 30-year period, with a basic farm setup (and no geometry or hydrophilic improvements) that means a cost-per-gallon somewhere in the range of $0.16 to $0.24.

While that is far higher than the current cost of water pumped from aquifers, a condensation farm, or large series of them, particularly in rural areas with high humidity and limited access to drinking water—especially if implemented at scale—could provide drinking water across wide regions for a minimal capital investment.

Plus, with only $10,000 per year in operating expenses, the long-term cost per gallon would continue to drop beyond the 30-year time horizon.

Again, this version doesn't include complex pipe geometry, nanopore (or other coatings) as well as optimization of pressures, dwell times, humidity sensing, and a host of other factors which can be tuned (via simple Arduino control systems) to increase water production.

Even with just a few of those things included, water production can nearly double from the smooth-bore-pipe base system, bringing the cost per gallon of water down to $0.10 to $0.15 per gallon.

And since the system is easily scalable, with 1,000 farms:

| Metric | Per Farm | | 1,000-Farm Total |
|---|---|---|---|
| Water Yield/year | 91,250 | gallons | 91,250,000 gallons/year |
| Water Yield (30 yrs) | 2,737,500 | gallons | 2,737,500,000 gallons |
| | | | (2.74B gal) |

| | | |
|---|---|---|
| CAPEX | $168K-$377K | $168M-$377M |
| OPEX/year | $9,000 | $9M/year |
| OPEX (30 yrs) | $270,000 | $270M |
| Total Cost (30 yrs) | $438K-$647K | $438M-$647M |
| Cost per gallon | $0.16-$0.24 | Same as per-farm basis |

Which means 2.7 billion gallons of clean water over 30 years, or enough for the drinking water needs of 250,000 people annually (at 1 gallon per person per day), and depending on where the water is priced, OPEX would largely be absorbed by ongoing water sales.

If you put $1 trillion into the invention here are some potential numbers just from the base system:

| CAPEX/Farm | Farms You Could Build | Total Acreage | Annual Water Yield |
|---|---|---|---|
| $168,000 | 5,952,381 | ~5.95 million acres | 543,402,758 gallons/year |
| $377,000 | 2,652,513 | ~2.65 million acres | 242,124,789 gallons/year |

But at that scale you start to run into a couple of problems. The first is that at the low-end CAPEX the total land area required is the combined size of New Hampshire and Vermont.

In certain regions (like Africa) or coastal desert areas with high humidity and zero population—that might actually make sense though.

But at the point the smaller condensation farm no longer becomes practical, you switch to the larger tunnel version. And at that point things get really interesting.

Capital Expenditures (CAPEX) - 1 km Copper-Lined Condensation Tunnel

| | | Estimated Cost |
|---|---|---|
| Category | Item | Range |
| #z,34; Structure & Surface | Tunnel shell (concrete or prefab) | $4M-$6M |
| | Copper coating (walls & ceiling-~72,500 m²) | $3.6M-$5.4M |
| | Gravel base + drainage trench system | $500K-$800K |
| | Thermal insulation layer | $1M-$1.5M |
| #z,35; Airflow System | Axial fans (high CFM, ~500 units) | $400K-$600K |
| | Fan mounts + ductwork | $250K-$400K |
| | Controllers (ESP32/Arduino) | $5K-$10K |
| | RH/Temp sensors (~200 units) | $50K-$80K |
| #z,36; Purification & Storage | RO + UV + remineralization skid | $25K-$40K |
| | Insulated reservoirs (10 units × 10,000 gol) | $150K-$250X |
| | Pumps + flow meters | $50K-$100K |
| | Distribution kiosks or outlets | $100K-$200K |
| #z,37; Power & Monitoring | Solar panels (~2,000 × 50 W) | $100K-$180K |
| | Wind turbines (4-6 units) | $80K-$120K |
| | LifePO₄ batteries (~2,000 units) | $160K-$240K |
| | Charge controllers + Inverters (~50 sets) | $50K-$80K |
| | Monitoring & control display panel | $1K-$2K |

Where you have $10-$15-million dollars in CAPEX per tunnel.

Annual Operating Expenses (OPEX)

| | | Estimated Annual |
|---|---|---|
| Category | Description | Cost |
| #z,38; Fan & Sensor Maintenance | Bearings, motor service, RH/temp sensor | $100,000 |
| | calibration | |
| #z,39; Filtration Upkeep | RO membrane, sediment/carbon filter | $25,000 |
| | replacements | |
| #z,40; Power System Maintenance | Solar panel cleaning, battery health | $20,000 |
| | monitoring | |
| #z,41; Sampling & QA Labor | Weekly reservoir checks, sample logging, | $50,000 |
| | troubleshooting | |
| #z,42; Insurance & Admin Overhead | Liability coverage, water usage data logging, | $15,000 |
| | auditing | |

And you can operate each tunnel for approximately $210.000 per year.

| | | Estimated Yield | |
|---|---|---|---|
| Location | Climate Profile | (gal/year) | Key Factors |
| Madison, Wi | Humid [symbol] ; warm summers, cold | [symbol] 3.5 million | Strong summer humidity; winter |
| | winters | gallons | yield drops due to low dew points |
| | | | and cold air |
| San Francisco, CA | Coastal Mediterranean; [symbol] , foggy year- | [symbol] 4.2-4.5 million | Marine layer and consistent fog |
| | round | gallons | boost condensation; stable year- |
| | | | round performance |

[symbol]

indicates data missing or illegible when filed

And depending on where a tunnel is placed, that means over a 30-year period, you could generate 105 million gallons of water in Madison, WI with a price per gallon of somewhere between $0.16 and $0.20 per gallon.

A basic tunnel in San Francisco would produce 135 million gallons over the same time period (because of higher average humidity and more consistent temperatures), with an average cost per gallon of $0.12-$0.16.

But again, you have to consider that these are just ballpark PER TUNNEL numbers.

Add in some of the improvements in terms of complex geometry discussed above, hydrophilic coatings, and so on—in Madison, WI the output jumps to about 5.6 million gallons annually, or nearly 168 million gallons over 30 years, with a cost-per-gallon between $0.096 and $0.13 depending on buildout costs.

In San Francisco, water output improves to 7 million gallons per year or 210 million gallons over 30 years with a cost-per-gallon of $0.077-and $0.10.

Build 1,000 of these tunnels and here's what you get:

| Category | Total for 1,000 Tunnels |
|---|---|
| CAPEX | $8.5B-$13.4B |
| OPEX | $7.658 |
| Total Cost | $16.15B-$21.05B |
| Water Output | 209.78 gallons |
| Cost/Gallon | $0.077-$0.10/gal |

209.7 billion gallons of water (over 30 years) is enough to meet the drinking water needs of 19,150,684 people (at 1 gallon per day).

Or with typical usage in San Francisco (42 gallons per person per day)—those 1,000 tunnels could support 455,968 people.

At $1 trillion,

| | Per Tunnel | $1T + | Total |
|---|---|---|---|
| Scenario | Cost | Cost | Tunnels |
| Low-end build | $16.15M | $1T + | 61,947 |
| | | $16.15M | tunnels |
| High-end build | $21.05M | $1T + | 47,519 |
| | | $21.05M | tunnels |

Meaning

| Scenario | Tunnels Built | 30-Year Water Yield |
|---|---|---|
| Low-end build | 61,947 | ~13.0 trillion gallons |
| High-end build | 47,519 | ~9.96 trillion gallons |

And if you make the following assumptions for 4 gallons per person per day (drinking+basic hygiene) you get the following:

People Served
At a minimum of 1,460 gallons/year/person (drinking + basic hygiene);

| Scenario | Water Yield | Annual Users Supported |
|---|---|---|
| Low-end build | 13.0T gallons | ~297 million people/year |
| High-end build | 9.96T gallons | ~228 million people/year |

Which if you consider the entirety of the US population, at 341,145,670, that's a capital expenditure of $1.1507 trillion-$1.4987 trillion. Or a total of 71,250 tunnels to service the drinking water and basic hygiene needs of the entire Nation.

However, at 42 gallons per person per day (a more reasonable number) that would mean 15,330 gallons per year or 459,900 gallons per person per 30-year period.

To service the water needs of the entire nation's personal water use at 42 gallons a day would require 748,742 tunnels with a capital cost of $12.09 trillion to $15.76 trillion.

However, you wouldn't actually need to build all of those tunnels—as a lot of water gets recycled through municipal water systems. And, well, things like rain and snow will keep happening.

But just in terms of raw numbers, over 30 years, at that level of capital expenditure and those per-tunnel production numbers—that's 157.03 trillion (157,026,055,400,000) gallons produced over 30 years.

The entirety of US Agricultural demand is currently 43 trillion gallons PER YEAR. To replace that you would need 6,163,000 tunnels.

Total 30-Year Cost for 6,163,000 Tunnels

| Scenario | Per Tunnel Cost | Total Cost |
|---|---|---|
| Low-end build | $16.15 million | $99.5 trillion |
| High-end build | $21.05 million | $129.8 trillion |

Which is quite a bit of cheese. But amortized over the next century, a capital investment of this kind would be a worthwhile investment for the Nation. Or any nation. Or the entire world.

Because once you scale the invention above human needs, and agricultural needs, and the needs of industry and business, and the needs for transportation and energy, well, the world would certainly look quite differently, will it not? Plenty of food, water, and energy, for all. Deserts and dry areas would be dry no longer. And that person—some centuries from now, on the front porch of a farmhouse, having a cup of coffee and looking out over fields of crops in what used to be the Sahara—well, isn't that a dream worth pursuing?

For all of us.

### Non-Obviousness of the Invention

Given that the first two claims of the 667 Application have been granted, we can also posit that additions to that same system are also unlikely to have been done before. So, while the use of somewhat complex geometries on the interiors of HVAC and cooling pipes in air conditioners is known—threaded pipe in HVAC systems is used primarily for the purpose of causing turbulence in refrigerants, not humid air. And while the various geometries used OUTSIDE of HVAC systems are well known, applying those and similar structures to the INTERIOR of small diameter pipes for the purpose of creating greater condensation (given that the 667 invention did not exist before) is also new and novel. Additionally, given the non-obviousness of the 667 claims, we can also state that it is unlikely that the INTERIORS of pipes have been coated with hydrophilic surfaces for the purpose of promoting condensation, even though those hydrophilic surfaces are commonplace on EXTERNAL fins of air conditioners, HVAC systems, and other heat-exchange systems. Therefore, the use of hydrophilic coatings on the interior surface of pipes to promote condensation is also new and novel when used in conjunction with the 667 invention (which didn't previously exist). Additionally, since the larger-bore system of claim 2 in the 667 Application has been granted and is new and novel, we can state that using an underground geothermally cooled tunnel for the purpose of condensing water is new and novel, and that as a result, additions and improvements to that system, such as complex geometries, fractal geometries, surface geometries, plates, louvers, fins, and other complex surfaces inside of a tunnel geared toward maximum condensation within that 667 claim 2 tunnel are also new and novel. In short, while many of these features are commonplace—either in mathematics or in HVAC and air conditioning systems, their application to this invention is not—as the invention itself did not previously exist prior to the 667 Application. Additionally, the layout and concept of a “condensation farm”—what happens when you put all of these things together in a single package-has not previously existed, either in the small 1-acre farm format, or the larger city- or regional-scale versions of the 667 invention. As such, a “condensation farm” and its proposed composition is also new and novel and claims related to that composition of elements should also be granted. Additionally, spaceship-based systems using the 667 claim 2 construction to produce methane from planetary atmospheres, dirigibles using the 667 claim 2 construction to produce water from Earth's atmosphere, and FIG. 36 iterations of the “humid air pipeline” porting humid air from the coast to altitudes with a usable thermal gradient and applying those thermal gradients to the 667 invention—are also new and novel.

1. An iteration of claim 1 in the 667 Application comprised by complex geometries used on the internal surface of a copper pipe creating additional surface area and creating turbulence in the laminar airflow creating additional condensation; and adding a plurality of potential hydrophilic coatings to the interior of the pipe.

2. An iteration of claim 2 in the 667 Application comprised by geometries affixed to the interior of the tunnel wall, including complex fractal metallic sculptures, flat metal plates or louvers, as well as geometrical modifications of the tunnel surface to increase overall surface area and create turbulence; the addition of hydrophilic coatings to the interior surfaces of the tunnel; and application of those hydrophilic coatings to the fractal structures, plates, louvers, or other tunnel projections; complex geometries on the surface of flat plates or louvers; complex fractal structures of any type attached to the tunnel wall to increase surface area, disrupt airflow, and increase condensation; copper pipes projecting perpendicularly from the tunnel wall toward the center line which are either solid or filled with circulating geothermally cooled water as in the 877 application; or copper pipes arranged in a cathedral pipe organ orientation from the tunnel floor to ceiling, and wherein water travels from tunnel ceiling to tunnel floor through those copper pipes, then to a geothermal loop, then back to the top of the tunnel completing the cooling cycle.

3. The design of a “condensation farm” comprised by elements of the 667 and 877 Applications, including free-standing 877 metal columns filled with geothermally cooled water exposed directly to humid air; 877 columns filled with geothermally cooled water surrounded by a pressure sleeve; subsurface 877 columns suspended in a metallically lined silo, wherein both the surface of the column filled with geothermally cooled water and the geothermally cooled surface of the metal adhered to the interior surface of the silo cause condensation to form; and iterations of claim 1 of the 667 Application wherein rows of copper pipes are laid out similar to rows of corn, and consist of fans and/or compressors, pipes, catchment basis, water purification modules, bottling facilities, water distribution/sales modules, and wherein all of those possible iterations of the invention include either the enhancements of claim 1 for smaller bore versions of the invention described in this application, and the enhancements of claim 2 for the larger tunnel and/or silo versions described in this application whether in a horizontal, tilted, or vertical orientation.

4. In one embodiment of a 1-acre condensation farm, that farm is comprised by 100 rows of smooth copper pipe 2 inches in diameter and 100 feet long, and those rows of 100 feet copper pipe are set at least 4 feet below the surface, and wherein axial inline fans at either end of the pipe cause 25 CFM of air to travel down the pipe requiring 200 total fans, and those fans are attached to the pipes with fan mount kits, and wherein 5 Arduino units measure moisture and control power to those fans, and wherein those pipes lead to a reservoir which leads to sediment and carbon filters leading to a reverse osmosis purification system including UV treatment and mineralization; and from which that water travels to a water kiosk in a secure housing allowing for users to pay for water; and prior to arriving at the kiosk a solenoid valve attached to the main water line from the reverse osmosis system takes a small sample of water and diverts it to an insulated sampling reservoir for later testing; and for power the system uses 100 50-watt solar panels and 100 LiFePO4 batteries to power the inline fan, water kiosk, and a low-pressure pump which transfers water from the reservoir to the RO system and the kiosk; and wherein inside of that kiosk TDS, pH, and temperature sensors capture quality tracking and post RO processing information, and a monitoring display system allows for overall monitoring of the system, and that same data can be streamed in real time to a user/owner's wireless device; and appropriate pipe connectors, cable runs and wiring is used to make the entire system into a working whole.

5. In another embodiment as in the 667 Application claim 2 the condensation farm is comprised by series of tunnels running in parallel, each of which is encased in a tunnel shell or prefabricated concrete, and the tunnel walls and ceiling are coated with copper; a gravel base or drainage trench system runs along the floor of the tunnel and in colder climates a thermal insulation layer is used to prevent freezing; and wherein large numbers of axial fans (500 or so) are housed in a facility at the top of the tunnel or are used in clusters at various points along the tunnel, and those fans have high CFM values, and those fans have mounting and ductwork appropriate to their usage; and wherein those fans are controlled by Arduino units connected to relative humidity and temperature sensors (200 units); and at the far end of the tunnel pumps and flow meters are used to transfer water from the tunnel to a reverse osmosis and remineralization skid; and both insulated and non-insulated reservoirs are used to hold excess water from the tunnel and excess water from post RO processing; and that processed water then travels to distribution kiosks or outlets for use by the public; and 2000 50 watt solar panels and 4-6 wind turbines power the system, and wherein power from the turbines and solar panels is held and disbursed from 2,000 LiFePO4 batteries; and charge controllers and inverters (50 units) are used for power management across the system; and a monitoring and control display system is used to monitor the system and the data from the system and Arduino control boards can be streamed to user/owner wireless devices.

6. An iteration of the 667 Application claim 2 comprised by a cylindrical spaceship with an umbilical which descends into the atmosphere of a methane (or other) planet, and methane gas is taken up into the inner core of the spaceship, and within that core of the spaceship is a tunnel, and that tunnel is filled with complex geometrical, fractal, or other structures to promote condensation and to disrupt laminar methane gas flows; and wherein that inner tunnel is in some embodiments surrounded by liquid hydrogen and in other embodiments is a simple shell; and the exterior surface of the spaceship has cooling towers and fins which are attached to the inner tunnel or ship surface wherein the tunnel surface, fractal structures, or metal plates or structures are attached to those cooling elements; and excess heat from those structures and the tunnel wall is wicked away into the −455 degree Fahrenheit environment of deep space vacuum; and wherein methane gas is sent down the interior of the tunnel, interacts with the cooling elements, towers, geometrical structures, and the tunnel spins inside the inner core of the spaceship and creates artificial gravity; and wherein that gravity is useful up to 75% of the tunnel radius and draws liquid methane down fractal or other structures (which are also spinning, and therefore have simulated gravity to varying degrees) connected to the interior surface of the tunnel; and drain holes in the surface of the tunnel are ported to methane storage tanks or reservoirs; and those reservoirs can then in turn be ported to fueling umbilicals where spaceships refuel using the methane as rocket fuel and/or the basis for reactor mass; and wherein this embodiment is not limited to the collection of methane but can be used to collect a variety of chemicals from useful atmospheres.

7. An Iteration of 667 claim 2 wherein humid air is collected in high humidity areas such as coastal regions or valleys and that humid air is sent via pipeline across the coastal plain and upwards towards mountains or areas of higher elevation with cooler temperatures and where versions of 667 claim 2 are exposed to external air as opposed to subsurface temperatures to create a thermal gradient, and wherein the 667 claim 2 tunnel is filled with geometrical structures, plates, or louvers at those elevations to increase internal surface area, and that 667 claim 2 system in some embodiments is connected to either subsurface 667 claim 1 or 667 claim 2 systems, and wherein water and/or residual compressed humid air from the main pipeline is directed down the mountainside or elevation; acceleration of the water down the mountainside can be captured by Pelton or Tesla turbines at the bottom of the mountain or elevation creating electricity; and that electricity can be sent via wire back to the coast and used to partially power the fans, compressors, or pumps sending humid air from the coast up to elevation.
